(19) United States
(12) Patent Application Publication
(10) Pub. No.: US 2026/0128305 A1
(43) Pub. Date: May 7, 2026

(54) POSITIVE ELECTRODE ACTIVE MATERIAL AND LITHIUM ION SECONDARY BATTERY

(71) Applicant: HONDA MOTOR CO., LTD., Tokyo (JP)

(72) Inventors: Takashi HAKARI, Saitama (JP); Shogo ASO, Tochigi (JP); Hajime KUDO, Tochigi (JP); Kazumasa SAKATSUME, Saitama (JP); Kazuki CHIBA, Saitama (JP); Akihisa TANAKA, Saitama (JP); Atsushi FURUKAWA, Tochigi (JP); Terumi FURUTA, Saitama (JP); Yoshiyuki MORITA, Saitama (JP); Tatsuya OKAYAMA, Tochigi (JP)

(21) Appl. No.: 19/378,591

(22) Filed: Nov. 4, 2025

(30) Foreign Application Priority Data
Nov. 6, 2024 (JP) 2024-194260

(51) Int. Cl. H01M 4/58; H01M 4/62; H01M 10/0525

(52) U.S. Cl. CPC H01M 4/582; H01M 4/625; H01M 10/0525

(57) ABSTRACT

There is provided a positive electrode active material containing a lithium-iron composite fluoride as a principal component and including carbon, wherein
the lithium-iron composite fluoride is represented by the following formula (1):

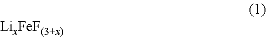

In the formula (1), x is a number satisfying 0.4≤x≤1.2.

### BACKGROUND

### Technical Field

The present invention relates to a positive electrode active material and a lithium ion secondary battery.

### Related Art

In recent years, research and development on a secondary battery that contributes to energy efficiency has been conducted in order for more people to be able to access affordable, reliable, sustainable, and advanced energy. In particular, a lithium ion secondary battery is becoming increasingly important as a power source for an electric vehicle (EV), a hybrid electric vehicle (HEV), or the like.

A positive electrode active material has attracted attention as an important component for determining a capacity of a lithium ion secondary battery, and development thereof has been advanced. As a positive electrode active material used for a lithium ion secondary battery, for example, iron (Fe)-based lithium iron phosphate (LiFePO₄) with low resource risk is known. LiFePO₄ is excellent in cycle characteristics and safety, but has a low voltage and a small capacity. Therefore, an energy density (voltage×capacity) represented by a product of the voltage and the capacity is small as compared with a conventionally used material based on nickel (Ni) or cobalt (Co). In order to construct a small battery, an electrode material with a high energy density is required, and in order to realize the high energy density, a high-voltage operation of a battery is important.

For the purpose of increasing the voltage of a battery using a material including an element with low resource risk, use of a high-valent transition metal (for example, not Fe²⁺⇔Fe³⁺ but Fe³⁺⇔Fe⁴⁺) is expected. However, Fe⁴⁺ is very unstable and becomes Fe³⁺ by side reaction, or Fe⁴⁺ requires a very large amount of energy and is not generated in some cases. Thus, even though a Fe³⁺ compound is used as the positive electrode active material, it is not necessarily capable of operating at a high voltage.

For example, it has been reported in F. Badway, et al., “Carbon Metal Fluoride Nanocomposites” J. Electrochem. Soc., 150(10) A1318-A1327 (2003) that LiFeF₃ is generated during charge and discharge by using ferric fluoride (FeF₃), and an average discharge voltage is 3.1 V. It has been reported in Y. Hu, et al., “A Simple, Quick and Eco-friendly Strategy of Synthesis Nanosized α-LiFeO₂ Cathode with Excellent Electrochemical Performance for Lithium-Ion Batteries” Materials, 11, 1176 (2018) that LiFeO₂ can be expected to have a high energy density.

### CITATION LIST

### Non Patent Literatures

Non Patent Literature 1: F. Badway, et al., “Carbon Metal Fluoride Nanocomposites” J. Electrochem. Soc., 150(10) A1318-A1327 (2003)
Non Patent Literature 2: Y. Hu, et al., “A Simple, Quick and Eco-Friendly Strategy of Synthesis Nanosized α-LiFeO₂ Cathode with Excellent Electrochemical Performance for Lithium-Ion Batteries” Materials, 11, 1176 (2018)

### SUMMARY

In Y. Hu, et al., “A Simple, Quick and Eco-friendly Strategy of Synthesis Nanosized α-LiFeO₂ Cathode with Excellent Electrochemical Performance for Lithium-Ion Batteries” Materials, 11, 1176 (2018), an actual voltage is about 2.5 V, which is lower than an expected voltage. The average discharge voltage (3.1 V) described in F. Badway, et al., “Carbon Metal Fluoride Nanocomposites” J. Electrochem. Soc., 150(10) A1318-A1327 (2003) is also lower than a voltage of LiFePO₄, and there is room for improvement in order to further increase the voltage.

The present invention has been made to solve the above problems, and an object thereof is to provide a positive electrode active material that is based on Fe and capable of operating at a high voltage, and a lithium ion secondary battery including the positive electrode active material. Furthermore, an additional object thereof is to reduce resource risk and contribute to cost reduction.

In order to achieve the above object, the present invention provides the following configurations.

[1] A positive electrode active material containing a lithium-iron composite fluoride as a principal component and including carbon, wherein
the lithium-iron composite fluoride is represented by the following formula (1):

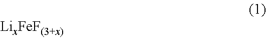

in the formula (1), x is a number satisfying 0.4≤x≤1.2.

The positive electrode active material according to [1] has a high average discharge voltage and can operate at a high voltage. Therefore, in a lithium ion secondary battery including the positive electrode active material, the number of batteries required can be reduced, thereby contributing to cost reduction.

[2] The positive electrode active material according to [1], wherein a mass ratio (M₁:M₂) between a mass (M₁) of the lithium-iron composite fluoride and a mass (M₂) of the carbon is 90:10 to 60:40.

The positive electrode active material according to [2] can increase a capacity of a lithium ion secondary battery containing the positive electrode active material, and can further increase an energy density.

[3] The positive electrode active material according to [1] or [2], in which a mass ratio (M₁:M₂) between a mass (M₁) of the lithium-iron composite fluoride and a mass (M₂) of the carbon is 90:10 to 80:20.

The positive electrode active material according to [3] can increase a capacity of a lithium ion secondary battery containing the positive electrode active material, and can further increase an energy density.

[4] The positive electrode active material according to any one of [1] to [3], wherein the carbon is a carbon nanotube or carbon black.

The positive electrode active material according to [4] can increase a capacity of a lithium ion secondary battery containing the positive electrode active material, and can further increase an energy density.

[5] A lithium ion secondary battery including a positive electrode, a negative electrode, and an electrolyte, wherein the positive electrode contains the positive electrode active material according to any one of [1] to [4].

In the lithium ion secondary battery according to [5], the positive electrode contains the positive electrode active material according to any one of [1] to [4]. This indicates that the battery can operate at a high voltage.

[6] The lithium ion secondary battery according to [5], wherein a dQ/dV plot during discharge in a charge-discharge cycle has a peak in a range of 3.94 to 4.01 V.

In the lithium ion secondary battery according to [6], the positive electrode active material undergoes a chemical reaction in a high voltage range of 3.94 to 4.01 V. This indicates that the battery can operate at a higher voltage.

[7] A lithium ion secondary battery including a positive electrode, a negative electrode, and an electrolyte, wherein
the positive electrode contains a positive electrode active material, and
the positive electrode active material includes a lithium-iron composite fluoride as a principal component and carbon, and
the lithium-iron composite fluoride is represented by the following formula (1):

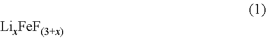

in the formula (1), x is a number satisfying 0.4≤x≤1.2,
a dQ/dV plot during discharge in a charge-discharge cycle has a peak in the range of 3.94 to 4.01 V.

The lithium ion secondary battery according to [7] has a high average discharge voltage and can operate at a high voltage. Therefore, the number of necessary batteries can be reduced, which contributes to cost reduction.

According to the present invention, it is possible to provide an Fe-based positive electrode active material capable of operating at a high voltage, and a lithium ion secondary battery including the positive electrode active material.

### BRIEF DESCRIPTION OF DRAWINGS

FIG. 1 is a diagram illustrating a part of an X-ray diffraction pattern of a positive electrode active material according to an embodiment of the present invention;

FIG. 2 is a diagram illustrating a part of an X-ray diffraction pattern of a positive electrode active material according to another embodiment of the present invention;

FIG. 3 is a cross-sectional view schematically illustrating a lithium ion secondary battery according to an embodiment of the present invention;

FIG. 4 is a graph illustrating a charge-discharge curve of a lithium ion secondary battery containing a positive electrode active material of Example 14;

FIG. 5 is a graph illustrating a dQ/dV plot in a charge-discharge cycle of a lithium ion secondary battery containing a positive electrode active material of Example 14;

FIG. 6 is a flowchart showing an example of a method for manufacturing a positive electrode active material according to an embodiment of the present invention;

FIG. 7 is a diagram illustrating X-ray diffraction patterns of positive electrode active materials of Examples 1 to 5 and Comparative Example 1;

FIG. 8 is a diagram illustrating X-ray diffraction patterns of positive electrode active materials of Examples 6 to 12;

FIG. 9 is a diagram illustrating a part of an X-ray diffraction pattern of a positive electrode active material of Example 8;

FIG. 10 is a diagram illustrating a part of an X-ray diffraction pattern of a positive electrode active material of Example 9;

FIG. 11 is a diagram illustrating a part of an X-ray diffraction pattern of a positive electrode active material of Example 13;

FIG. 12 is a diagram illustrating a part of an X-ray diffraction pattern of a positive electrode active material of Example 15;

FIG. 13 is a diagram illustrating a part of an X-ray diffraction pattern of a positive electrode active material of Example 16;

FIG. 14 is a diagram illustrating a part of an X-ray diffraction pattern of a positive electrode active material of Example 17;

FIG. 15 is a diagram illustrating a part of an X-ray diffraction pattern of a positive electrode active material of Example 18;

FIG. 16 is a diagram illustrating a part of an X-ray diffraction pattern of a positive electrode active material of Example 19;

FIG. 17 is a graph illustrating a charge-discharge curve of a lithium ion secondary battery containing a positive electrode active material of Example 1;

FIG. 18 is a graph illustrating a charge-discharge curve of a lithium ion secondary battery containing a positive electrode active material of Example 2;

FIG. 19 is a graph illustrating a charge-discharge curve of a lithium ion secondary battery containing a positive electrode active material of Example 3;

FIG. 20 is a graph illustrating a charge-discharge curve of a lithium ion secondary battery containing a positive electrode active material of Example 4;

FIG. 21 is a graph illustrating a charge-discharge curve of a lithium ion secondary battery containing a positive electrode active material of Example 5;

FIG. 22 is a graph illustrating a charge-discharge curve of a lithium ion secondary battery containing a positive electrode active material of Example 6;

FIG. 23 is a graph illustrating a charge-discharge curve of a lithium ion secondary battery containing a positive electrode active material of Example 7;

FIG. 24 is a graph illustrating a charge-discharge curve of a lithium ion secondary battery containing a positive electrode active material of Example 8;

FIG. 25 is a graph illustrating a charge-discharge curve of a lithium ion secondary battery containing a positive electrode active material of Example 9;

FIG. 26 is a graph illustrating a charge-discharge curve of a lithium ion secondary battery containing a positive electrode active material of Example 10;

FIG. 27 is a graph illustrating a charge-discharge curve of a lithium ion secondary battery containing a positive electrode active material of Example 12;

FIG. 28 is a graph illustrating a charge-discharge curve of a lithium ion secondary battery containing a positive electrode active material of Example 13;

FIG. 29 is a graph illustrating a charge-discharge curve of a lithium ion secondary battery containing a positive electrode active material of Example 15;

FIG. 30 is a graph illustrating a charge-discharge curve of a lithium ion secondary battery containing a positive electrode active material of Example 16;

FIG. 31 is a graph illustrating a charge-discharge curve of a lithium ion secondary battery containing a positive electrode active material of Example 17;

FIG. 32 is a graph illustrating a charge-discharge curve of a lithium ion secondary battery containing a positive electrode active material of Example 18;

FIG. 33 is a graph illustrating a charge-discharge curve of a lithium ion secondary battery containing a positive electrode active material of Example 19;

FIG. 34 is a graph illustrating a charge-discharge curve of a lithium ion secondary battery containing a positive electrode active material of Comparative Example 1;

FIG. 35 is a graph illustrating a charge-discharge curve of a lithium ion secondary battery containing a positive electrode active material of Comparative Example 2;

FIG. 36 is a graph illustrating a charge-discharge curve of a lithium ion secondary battery containing a positive electrode active material of Comparative Example 3;

FIG. 37 is a graph illustrating a charge-discharge curve of a lithium ion secondary battery containing a positive electrode active material of Comparative Example 4;

FIG. 38 is a graph illustrating a dQ/dV plot in a charge-discharge cycle of a lithium ion secondary battery containing a positive electrode active material of Example 1;

FIG. 39 is a graph illustrating a dQ/dV plot in a charge-discharge cycle of a lithium ion secondary battery containing a positive electrode active material of Example 2;

FIG. 40 is a graph illustrating a dQ/dV plot in a charge-discharge cycle of a lithium ion secondary battery containing a positive electrode active material of Example 3;

FIG. 41 is a graph illustrating a dQ/dV plot in a charge-discharge cycle of a lithium ion secondary battery containing a positive electrode active material of Example 4;

FIG. 42 is a graph illustrating a dQ/dV plot in a charge-discharge cycle of a lithium ion secondary battery containing a positive electrode active material of Example 5;

FIG. 43 is a graph illustrating a dQ/dV plot in a charge-discharge cycle of a lithium ion secondary battery containing a positive electrode active material of Example 6;

FIG. 44 is a graph illustrating a dQ/dV plot in a charge-discharge cycle of a lithium ion secondary battery containing a positive electrode active material of Example 7;

FIG. 45 is a graph illustrating a dQ/dV plot in a charge-discharge cycle of a lithium ion secondary battery containing a positive electrode active material of Example 8;

FIG. 46 is a graph illustrating a dQ/dV plot in a charge-discharge cycle of a lithium ion secondary battery containing a positive electrode active material of Example 9;

FIG. 47 is a graph illustrating a dQ/dV plot in a charge-discharge cycle of a lithium ion secondary battery containing a positive electrode active material of Example 10;

FIG. 48 is a graph illustrating a dQ/dV plot in a charge-discharge cycle of a lithium ion secondary battery containing a positive electrode active material of Example 12;

FIG. 49 is a graph illustrating a dQ/dV plot in a charge-discharge cycle of a lithium ion secondary battery containing a positive electrode active material of Example 13;

FIG. 50 is a graph illustrating a dQ/dV plot in a charge-discharge cycle of a lithium ion secondary battery containing a positive electrode active material of Example 15;

FIG. 51 is a graph illustrating a dQ/dV plot in a charge-discharge cycle of a lithium ion secondary battery containing a positive electrode active material of Example 16;

FIG. 52 is a graph illustrating a dQ/dV plot in a charge-discharge cycle of a lithium ion secondary battery containing a positive electrode active material of Example 17;

FIG. 53 is a graph illustrating a dQ/dV plot in a charge-discharge cycle of a lithium ion secondary battery containing a positive electrode active material of Example 18;

FIG. 54 is a graph illustrating a dQ/dV plot in a charge-discharge cycle of a lithium ion secondary battery containing a positive electrode active material of Example 19;

FIG. 55 is a graph illustrating a dQ/dV plot in a charge-discharge cycle of a lithium ion secondary battery containing a positive electrode active material of Comparative Example 1;

FIG. 56 is a graph illustrating a dQ/dV plot in a charge-discharge cycle of a lithium ion secondary battery containing a positive electrode active material of Comparative Example 2;

FIG. 57 is a graph illustrating a dQ/dV plot in a charge-discharge cycle of a lithium ion secondary battery containing a positive electrode active material of Comparative Example 3;

FIG. 58 is a graph illustrating a dQ/dV plot in a charge-discharge cycle of a lithium ion secondary battery containing a positive electrode active material of Comparative Example 4;

FIG. 59 is a graph illustrating a charge-discharge curve of a lithium ion secondary battery containing a positive electrode active material of Example 20; and

FIG. 60 is a graph illustrating a dQ/dV plot in a charge-discharge cycle of a lithium ion secondary battery containing a positive electrode active material of Example 20.

### DETAILED DESCRIPTION

Hereinafter, a preferred embodiment of the present invention will be described in detail.

### [Positive Electrode Active Material]

The positive electrode active material of the present embodiment includes a lithium-iron composite fluoride as a principal component and carbon. The positive electrode active material of the present embodiment is used for a positive electrode of a lithium ion secondary battery. The phrase “includes a lithium-iron composite fluoride as a principal component” means that the content of the lithium-iron composite fluoride is 50% by mass or more, preferably 60% by mass or more, more preferably 70% by mass or more, and still more preferably 80% by mass or more with respect to the total mass of the positive electrode active material. The positive electrode active material may include a component other than the principal component and carbon as long as a function of the present invention is not impaired.

The positive electrode active material of the present embodiment may include only one kind or two or more kinds of lithium-iron composite fluorides as long as the lithium-iron composite fluoride is included as a principal component.

In a case where the positive electrode active material is manufactured by using the lithium-iron composite fluoride as a principal component, a total composition ratio (Li:Fe:F) of the lithium-iron composite fluoride is also maintained in the obtained positive electrode active material. In a case where the positive electrode active material obtained by using the lithium-iron composite fluoride having such a composition as a principal component is used in a secondary battery, a high-voltage operation can be achieved. In addition, the composition ratio of the lithium-iron composite fluoride is adjusted to be similar to a composition ratio required for a positive electrode active material to be obtained.

### (Lithium-Iron Composite Fluoride)

The lithium-iron composite fluoride of the present embodiment is represented by the following formula (1).

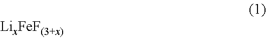

In the formula (1), x is a number satisfying 0.4≤x≤1.2. In the formula (1), x is preferably 0.5≤x≤1.0, and more preferably 0.6≤x≤0.9. When x is within the above numerical range, a small battery having an increased average discharge voltage, an increased capacity, and a high energy density can be constructed.

In formula (1), x represents a molar ratio between Li and Fe. The molar ratio between Li and Fe is x:1. A molar ratio among Li, Fe, and F is x:1:(3+x).

The composition of the lithium-iron composite fluoride can be determined by inductively coupled plasma (ICP) emission spectrometry, combustion ion chromatography, or the like.

### (Carbon)

Carbon in the present embodiment means a simple substance of carbon. Examples of the simple substance of carbon include carbon nanotubes, carbon black, graphite, and diamond. As a simple substance of these carbons, carbon nanotubes or carbon black are preferable from the viewpoint of more suitably obtaining the effect of the present invention.

The content of carbon in the present embodiment is preferably 90:10 to 60:40, more preferably 90:10 to 70:30, and still more preferably 90:10 to 80:20 in terms of a mass ratio (M₁:M₂) between the mass (M₁) of the lithium-iron composite fluoride and the mass (M₂) of carbon. When the mass ratio (M₁:M₂) is within the above numerical range, the capacity of the lithium ion secondary battery can be increased, and the energy density can be further increased.

### <X-Ray Diffraction (XRD) Pattern>

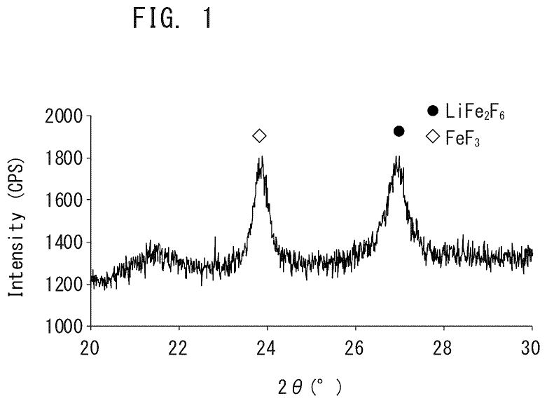

FIG. 1 illustrates, as an example of a part of an X-ray diffraction (XRD) pattern of the positive electrode active material according to the present embodiment, an XRD pattern of Example 7 described later. As illustrated in FIG. 1, the positive electrode active material of Example 7 has peaks in the range of 20°≤2θ<25θ and the range of 25°≤2θ≤30°, respectively. The peak in the range of 20°≤2θ<25° represents a peak derived from a crystal structure of FeF₃ which is trivalent iron. The peak in the range of 25°≤2θ≤30° represents a peak derived from a crystal structure of LiFe₂F₆. This means that the positive electrode active material of Example 7 has a similar crystal structure to those of FeF₃ and LiFe₂F₆.

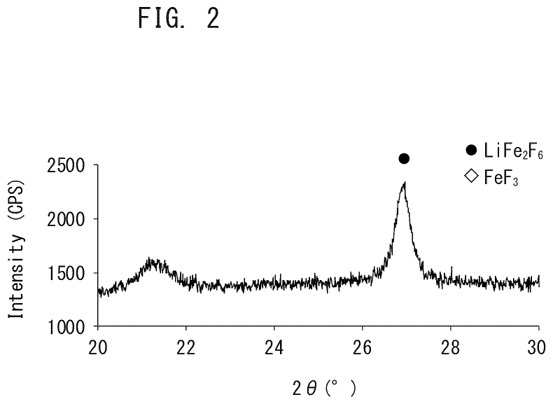

Next, FIG. 2 illustrates a part of an XRD pattern of Example 14 described later. As illustrated in FIG. 2, in the positive electrode active material of Example 14, a peak in the range of 20°≤2θ<25° disappears. This means that the positive electrode active material of Example 14 is in a single phase state having only the similar crystal structure as LiFe₂F₆.

As described above, by controlling the crystal structure of the lithium-iron composite fluoride contained in the positive electrode active material of the present embodiment to be in a single phase state, the capacity of the lithium ion secondary battery containing the positive electrode active material can be further increased, and the energy density can be further increased.

### [Lithium Ion Secondary Battery]

The lithium ion secondary battery of the present embodiment includes a positive electrode, a negative electrode, and an electrolyte, and the positive electrode contains a positive electrode active material containing the above-described lithium-iron composite fluoride as a principal component. The lithium ion secondary battery of the present embodiment may include other battery elements as necessary.

In the lithium ion secondary battery of the present embodiment, a battery element of a known lithium ion secondary battery can be adopted as it is except that the positive electrode contains a positive electrode active material containing the above-described lithium-iron composite fluoride as a principal component and including carbon. The lithium ion secondary battery of the present embodiment may have any of a coin type, a button type, a cylindrical type, a square type, and a laminate type. In addition, the lithium ion secondary battery of the present embodiment can be applied to a wide range of applications such as a mobile device such as a mobile phone or a laptop computer, and in-vehicle applications.

Hereinafter, as for the lithium ion secondary battery of the present embodiment, a lithium ion secondary battery (coin-type lithium ion secondary battery) using an electrolytic solution will be described. Each battery element described below can be similarly applied to an all-solid-state lithium ion secondary battery or a semi-solid lithium ion secondary battery not using an electrolytic solution.

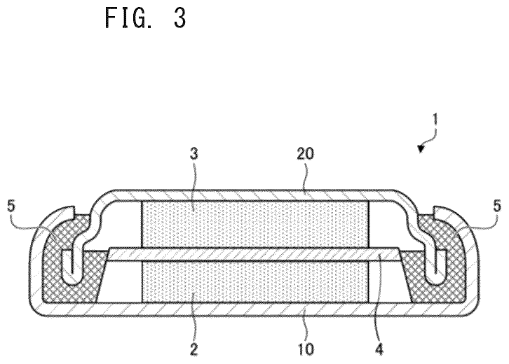

As illustrated in FIG. 3, a lithium ion secondary battery 1 of this embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed below the separator 4, the negative electrode can 20 is disposed above the separator 4, and the outer shape of the lithium ion secondary battery 1 is formed by the positive electrode can 10 and the negative electrode can 20. The positive electrode 2 and the negative electrode 3 are disposed between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium ion secondary battery 1, the positive electrode 2 can be prepared by blending a conductive agent, a binder, and the like with the positive electrode active material of the present embodiment as necessary to prepare a positive electrode mixture, and pressing the positive electrode mixture to a current collector (not illustrated).

As the current collector, a stainless steel mesh, an aluminum foil, or the like can be preferably used. As the conductive agent, a carbon nanotube (CNT), acetylene black, Ketjenblack, or the like can be preferably used. As the binder, tetrafluoroethylene, polyvinylidene fluoride, or the like can be preferably used.

Blending of the positive electrode active material, the conductive agent, and the binder in the positive electrode mixture is not particularly limited. The content of the positive electrode active material in the positive electrode mixture is preferably 75% to 100% by mass, and more preferably 90% to 99% by mass. The content of the conductive agent in the positive electrode mixture is preferably 1% to 15% by mass, and more preferably 0.1% to 5% by mass. The content of the binder in the positive electrode mixture is preferably 0.1% to 10% by mass, and more preferably 0.1% to 5% by mass.

In the lithium ion secondary battery 1, as the negative electrode 3 with respect to the positive electrode 2, a known electrode that functions as a negative electrode active material and can intercalate and release lithium, for example, a metal-based material such as metallic lithium or a lithium alloy, a carbon-based material such as graphite or mesocarbon microbeads (MCMB), or a silicon-based material such as silicon (Si), a Si alloy, or silicon oxide can be adopted. Among these materials, metallic lithium and graphite are preferable as the negative electrode 3.

Known battery elements can be adopted as the separator 4 and the battery containers (positive electrode can 10 and negative electrode can 20).

As the electrolyte, a known electrolytic solution, a known semi-solid electrolyte, a known solid electrolyte, or the like can be adopted. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

As the semi-solid electrolyte and the solid electrolyte, a known semi-solid electrolyte and a known solid electrolyte can be used except that a positive electrode active material containing the above-described lithium-iron composite fluoride as a principal component and including carbon is used.

Examples of the semi-solid electrolyte include an electrolyte containing a polymer component and a standard electrolytic solution. Examples of the polymer component include polyvinylidene fluoride (PVDF)/polyethylene oxide (PEO), polyacrylonitrile (PAN)/PEO, polymethyl methacrylate (PMMA), PVDF/hexafluoropropylene (HFP), and other polymer components. Examples of the standard electrolytic solution include a 1 mol/L lithium hexafluorophosphate (LiPF₆) EC/DMC solution, a 1 mol/L LiPF₆ EC/ethyl methyl carbonate (EMC) solution, and a 1 mol/L LiPF₆ EC/DMC/EMC solution.

In a case of the all-solid-state lithium ion secondary battery, as the electrolyte, for example, a solid electrolyte such as a polymer-based solid electrolyte such as a polyethylene oxide-based polymer compound or a polymer compound including at least one or more of a polyorganosiloxane chain and a polyoxyalkylene chain, a sulfide-based solid electrolyte, or an oxide-based solid electrolyte can be used.

As for a positive electrode of the all-solid-state lithium ion secondary battery, for example, a positive electrode mixture including a solid electrolyte in addition to the positive electrode active material, the conductive agent, and the binder described above can be supported on a positive electrode current collector such as aluminum, nickel, or stainless steel.

The lithium ion secondary battery 1 of the present embodiment can operate at a high voltage because the positive electrode 2 contains the positive electrode active material of the present embodiment.

<dQ/dV Plot of Charge-Discharge Cycle>

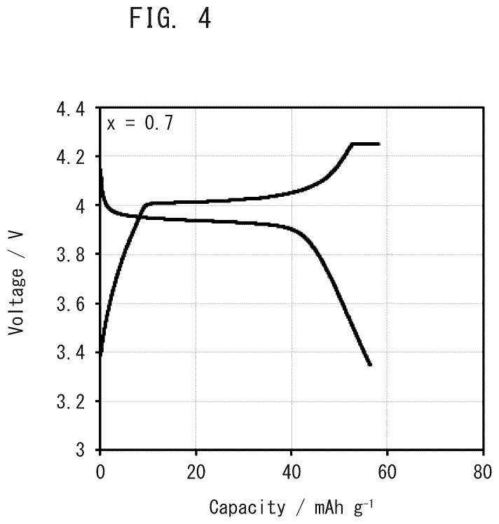

FIG. 4 illustrates a graph for Example 14 described later as an example of a charge-discharge curve in a charge-discharge cycle of the lithium ion secondary battery of the present embodiment. The horizontal axis of the graph in FIG. 4 represents a capacity of the lithium ion secondary battery. The vertical axis of the graph in FIG. 4 represents a voltage of the lithium ion secondary battery during charge and discharge. In the charge-discharge curve of FIG. 4, the right-upward curve represents a curve during charge, and the right-downward curve represents a curve during discharge.

The capacity of the lithium ion secondary battery illustrated in FIG. 4 is 56.2 mAh/g.

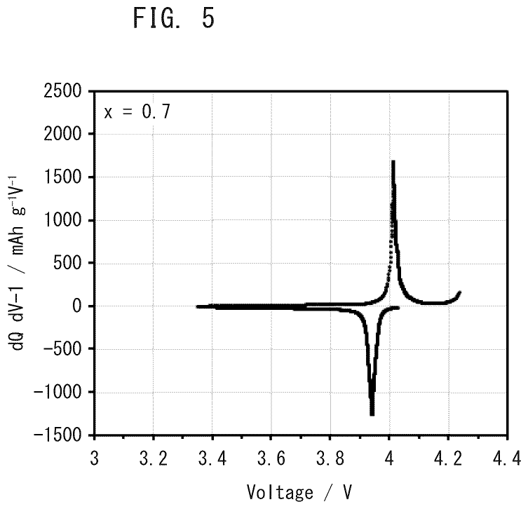

FIG. 5 illustrates a dQ/dV plot in the charge-discharge cycle of FIG. 4. The horizontal axis of the graph in FIG. 5 represents a voltage in the charge-discharge cycle. The vertical axis of the graph in FIG. 5 represents a value (dQ/dV plot, dQdV⁻¹ plot) obtained by differentiating the capacity in FIG. 4 with the voltage. In FIG. 5, the upwardly convex curve represents a curve during charge, and the downwardly convex curve represents a curve during discharge.

As illustrated in FIG. 5, the curve at the time of charging has a peak at 4.01 V. The curve during discharge has a peak at 3.94 V. These peaks indicate that the positive electrode active material undergoes a chemical reaction in the positive electrode during charge or discharge. This indicates that a chemical reaction occurs at a high voltage of 3.94 V during discharge, indicating that the lithium ion secondary battery can be operated at a high voltage.

In the lithium ion secondary battery of the present embodiment, it is preferable that a dQ/dV plot during discharge in a charge-discharge cycle has a peak in a range of 3.94 to 4.01 V. The fact that the dQ/dV plot during discharge in the charge-discharge cycle has a peak within the above numerical range means that the lithium ion secondary battery can be operated at a higher voltage.

In the present specification, the dQ/dV plot “has a peak” means that the dQ/dV plot has a mountain (“valley” in the case of a plot during discharge) having a height (“depth” in the case of a plot during discharge) of 40 mAhg⁻¹V⁻¹ or more.

In the lithium ion secondary battery of the present embodiment, a peak depth of a dQ/dV plot during discharge in a charge-discharge cycle is preferably 40 mAhg⁻¹V⁻¹ or more, more preferably 100 mAhg⁻¹V⁻¹ or more, still more preferably 200 mAhg⁻¹V⁻¹ or more, and particularly preferably 500 mAhg⁻¹V¹ or more. When the peak depth of the dQ/dV plot is the lower limit or more, the capacity of the lithium ion secondary battery can be further increased. The maximum value of the peak depth of the dQ/dV plot is not particularly limited, but is preferably, for example, 5000 mAhg⁻¹V⁻¹ or less.

The “peak depth” is given by the depth of the valley (absolute value of the value of the valley bottom) in the dQ/dV plot.

### [Method for Manufacturing Positive Electrode Active Material]

The positive electrode active material of the present embodiment includes the above-described lithium-iron composite fluoride as a principal component and contains carbon. As a lithium source of the lithium-iron composite fluoride, it is possible to use a known compound such as a halide such as lithium fluoride (LiF), a hydroxide such as lithium hydroxide monohydrate (LiOH·H₂O), a carbonate such as lithium carbonate (Li₂CO₃), or an acetate such as lithium acetate (CH₃COOLi) or lithium acetate dihydrate (CH₃COOLi·2H₂O), and there is no particular limitation.

As an iron source of the lithium-iron composite fluoride, trivalent iron is preferable rather than divalent iron, and ferric fluoride (FeF₃) is more preferable because high-voltage operation can be performed.

When the lithium-iron composite fluoride is manufactured, the above-described lithium source and iron source are mixed and subjected to a first mechanical processing under predetermined conditions for a predetermined time. For example, when lithium fluoride is used as the lithium source, and trivalent iron (FeF₃) is used as the iron source, it is considered that the compound represented by the above formula (1) can be formed by the following reaction.
LiF+FeF₃→LiFeF₄ (compound in which x=1 in the above formula (1))

A value of x in the compound represented by the above formula (1) can be adjusted by a molar ratio between LiF and FeF₃.

A specific unit applied in the first mechanical processing is not particularly limited, but various units conventionally used for the purpose of pulverizing and mixing a solid substance can be applied. Among these units, a ball mill is preferable, and a planetary ball mill is more preferable because raw materials can be sufficiently pulverized and mixed.

A time for performing the first mechanical processing is preferably, for example, 8 to 12 hours, and more preferably 9 to 11 hours.

As a condition for performing the first mechanical processing, a rotation speed is preferably 250 to 450 rpm, and more preferably 300 to 400 rpm.

A temperature at which the first mechanical processing is performed is not particularly limited, and the mechanical processing can be performed at room temperature (for example, 5° C. to 30° C.).

An atmosphere for the first mechanical processing is preferably an inert gas (a rare gas such as argon (Ar), a nitrogen (N₂) gas, or the like)

Carbon is added to and mixed with the lithium-iron composite fluoride obtained by the first mechanical processing, and a second mechanical processing is performed under predetermined conditions for a predetermined time.

By performing the second mechanical processing, the capacity and rate characteristics of the lithium ion secondary battery can be improved.

Examples of the carbon to be added include the simple substance of carbon described above, and carbon fine particles are preferable. As the carbon fine particles, for example, carbon nanotube (CNT), carbon black, or the like can be used. Among these carbon fine particles, the CNT is preferable from a viewpoint of further improving conductivity of the positive electrode active material.

Conditions (means, time, rotation speed, temperature, atmosphere, and the like) for performing the second mechanical processing are similar to the conditions for performing the first mechanical processing.

The composite of a lithium-iron composite fluoride and carbon obtained by the second mechanical processing is preferably subjected to a heat treatment. By subjecting the lithium-iron composite fluoride to the heat treatment, a crystal structure in the lithium-iron composite fluoride changes, and a capacity of a lithium ion secondary battery using the composite as a positive electrode active material can be increased.

This is considered to be because a composition ratio between a crystal structure of LiFe₂F₆ and a crystal structure of FeF₃ in the lithium-iron composite fluoride changes by the heat treatment, and the crystal structure of LiFe₂F₆ increases.

By subjecting the composite of a lithium-iron composite fluoride and carbon to the heat treatment, the capacity of the lithium ion secondary battery containing the composite as a positive electrode active material can be further increased, and the energy density can be further increased.

A firing temperature in the heat treatment is preferably 100 to 300° C., more preferably 150 to 250° C., and still more preferably 175 to 225° C.

A firing time in the heat treatment is preferably 0.5 to 20 hours, more preferably 2 to 15 hours, and still more preferably 4 to 8 hours.

An atmosphere in the heat treatment is preferably an inert gas (a rare gas such as argon (Ar), a nitrogen (N₂) gas, or the like)

A pressure in the heat treatment may be normal pressure (0.1013 MPa), but is preferably low vacuum (for example, 10² Pa to 10⁵ Pa).

The composite of lithium-iron composite fluoride and carbon described above may be used as a positive electrode active material, or a composite obtained by subjecting the composite to the heat treatment (heat-treated composite) may be used as a positive electrode active material.

By preparing a lithium ion secondary battery with the obtained positive electrode active material as a positive electrode, a battery that operates at a high voltage can be obtained.

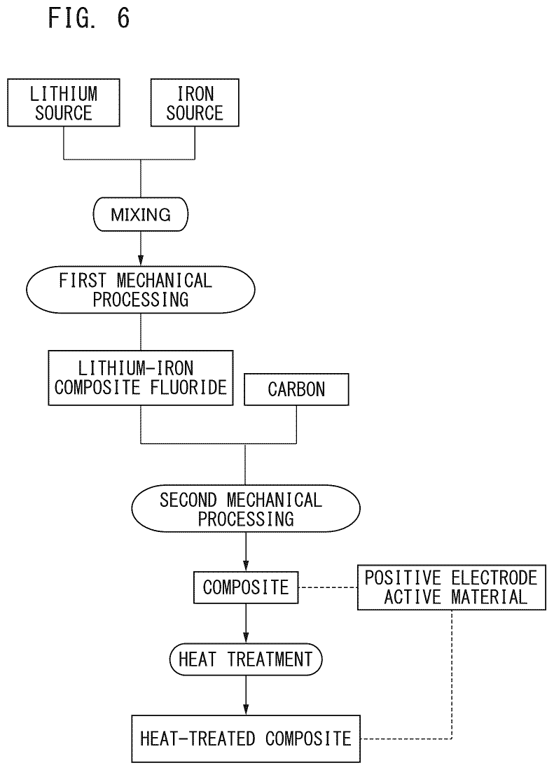

A method for manufacturing the positive electrode active material of the present embodiment is illustrated in a flowchart in FIG. 6. The meaning of each term in FIG. 6 is the same as the meaning of the term described above.

### EXAMPLES

Next, examples of the present invention will be described, but the present invention is not limited to the examples below.

### Example 1

(Preparation of Composite of Li_{0.6}FeF_{3.6} (Compound with x=0.6 in Formula (1)) and CNT=10% by Mass)

First mechanical processing was performed with 0.439 g of ferric fluoride (FeF₃) and 0.0606 g of lithium fluoride (LiF) by using a planetary ball mill machine. As the planetary ball mill machine, Premium line PL-7 manufactured by Fritsch GmbH was used. A pot and balls were made of zirconium oxide, and 50 g of the balls with a diameter of 5 mm was used in the 80 mL pot. The processing conditions of the first mechanical processing were 350 rpm and 10 hours. Thereafter, 0.55 g of carbon nanotube (CNT) was added into the pot, and the second mechanical processing was performed to obtain a positive electrode active material. The processing conditions of the second mechanical processing were 25° C., 350 rpm, and 10 hours in an Ar atmosphere.

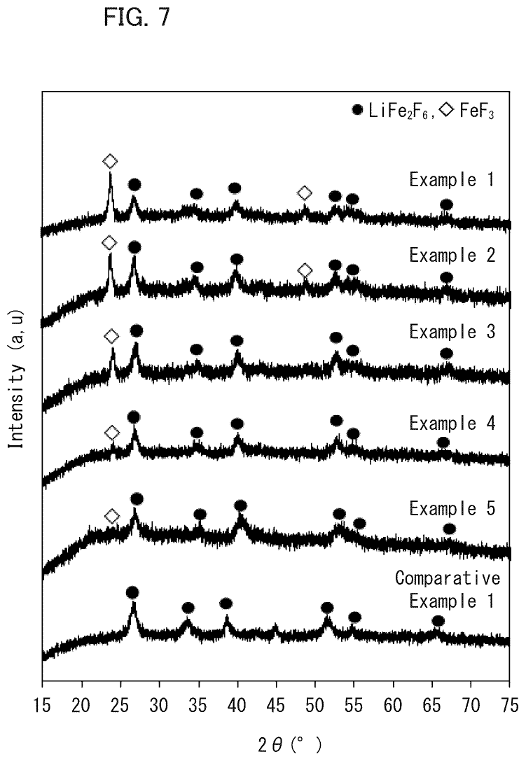

The obtained positive electrode active material was subjected to X-ray diffraction measurement according to the following measurement conditions. The results are illustrated in FIG. 7.

### <<X-Ray Diffraction Measurement Conditions>>

X-ray diffractometer: SmartLab manufactured by Rigaku Corporation
X-ray source: CuKα radiation (CuKα=1.5418 Å)
Opening angle of incident parallel slit: 5.0°
Length of incident longitudinal limiting slit: 5.0 mm
Opening angle of receiving parallel slit: 5.0°
Kβ filter: Used
Step width: 0.01°
Incident slit: 1/6°
Receiving slit 1: 4.0 mm
Receiving slit 2: 13 mm

As illustrated in FIG. 7, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 2

(Preparation of Composite of Li_{0.7}FeF_{3.7} (Compound with x=0.7 in Formula (1)) and CNT=10% by Mass)

A positive electrode active material was obtained in a similar manner to Example 1 except that 0.431 g of ferric fluoride (FeF₃) and 0.0693 g of lithium fluoride (LiF) were subjected to the first mechanical processing by using a planetary ball mill machine.

The obtained positive electrode active material was subjected to X-ray diffraction measurement under similar conditions to those in Example 1. The results are illustrated in FIG. 7.

As illustrated in FIG. 7, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 3

(Preparation of Composite of Li_{0.8}FeF_{3.8} (Compound with x=0.8 in Formula (1)) and CNT=10% by Mass)

A positive electrode active material was obtained in a similar manner to Example 1 except that 0.422 g of ferric fluoride (FeF₃) and 0.078 g of lithium fluoride (LiF) were subjected to the first mechanical processing by using a planetary ball mill machine.

The obtained positive electrode active material was subjected to X-ray diffraction measurement under similar conditions to those in Example 1. The results are illustrated in FIG. 7.

As illustrated in FIG. 7, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 4

(Preparation of Composite of LiFeF₄ (Compound of Formula (1) with x=1.0) and CNT=10% by Mass)

A positive electrode active material was obtained in a similar manner to Example 1 except that 0.407 g of ferric fluoride (FeF₃) and 0.0934 g of lithium fluoride (LiF) were subjected to the first mechanical processing by using a planetary ball mill machine.

The obtained positive electrode active material was subjected to X-ray diffraction measurement under similar conditions to those in Example 1. The results are illustrated in FIG. 7.

As illustrated in FIG. 7, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 5

(Preparation of Composite of Li_{1.2}FeF_{4.2} (Compound with x=1.2 in Formula (1)) and CNT=10% by Mass)

A positive electrode active material was obtained in a similar manner to Example 1 except that 0.391 g of ferric fluoride (FeF₃) and 0.108 g of lithium fluoride (LiF) were subjected to the first mechanical processing by using a planetary ball mill machine.

The obtained positive electrode active material was subjected to X-ray diffraction measurement under similar conditions to those in Example 1. The results are illustrated in FIG. 7.

As illustrated in FIG. 7, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Comparative Example 1

### (Preparation of Composite of LiFeF₃ and CNT=10% by Mass)

A positive electrode active material was obtained in a similar manner to Example 1 except that 0.392 g of ferrous fluoride (FeF₂) and 0.108 g of lithium fluoride (LiF) were subjected to the first mechanical processing by using a planetary ball mill machine.

The obtained positive electrode active material was subjected to X-ray diffraction measurement under similar conditions to those in Example 1. The results are illustrated in FIG. 7.

As illustrated in FIG. 7, a diffraction pattern of the obtained positive electrode active material coincided with a diffraction pattern of LiFe₂F₆ of a tetragonal crystal system in a P42/mnm space group with DB card number 01-074-2193, and it was found that the obtained positive electrode active material had a crystal structure similar to that of LiFe₂F₆.

### Example 6

The positive electrode active material obtained in Example 1 was subjected to a heat treatment at 103 Pa in an argon gas atmosphere at 200° C. by using an oven for five hours.

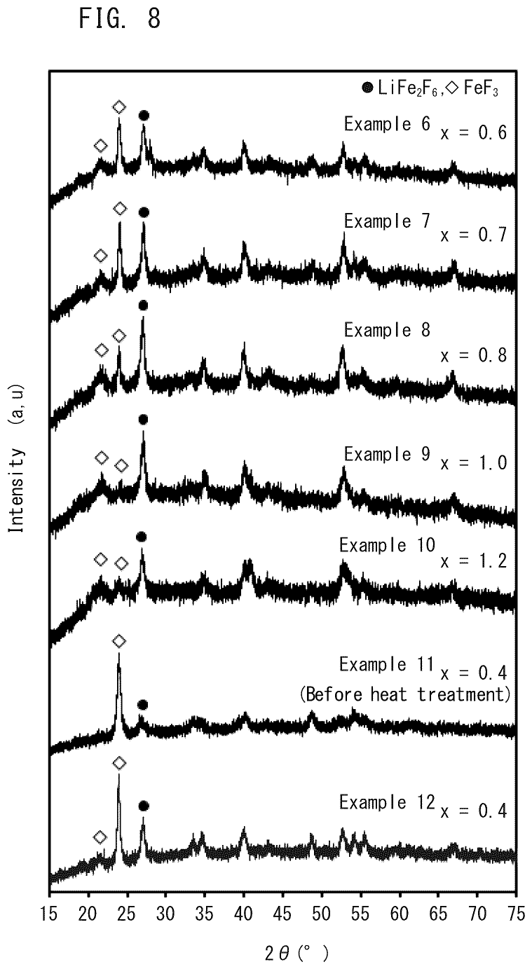

The obtained positive electrode active material was subjected to X-ray diffraction measurement under similar conditions to those in Example 1. The results are illustrated in FIG. 8.

As illustrated in FIG. 8, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 7

The positive electrode active material obtained in Example 2 was subjected to a heat treatment under similar conditions to Example 6, and the obtained positive electrode active material was subjected to X-ray diffraction measurement under similar conditions to Example 1. The results are illustrated in FIG. 8.

As illustrated in FIG. 8, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

Among the results, FIG. 1 illustrates a part of the XRD pattern (enlarged view at 20°≤2θ≤30°).

As illustrated in FIG. 1, it was found that the obtained positive electrode active material had a peak derived from the crystal structure of FeF₃ and a peak derived from the crystal structure of LiFe₂F₆.

### Example 8

The positive electrode active material obtained in Example 3 was subjected to a heat treatment under similar conditions to Example 6, and the obtained positive electrode active material was subjected to X-ray diffraction measurement under similar conditions to Example 1. The results are illustrated in FIG. 8.

As illustrated in FIG. 8, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

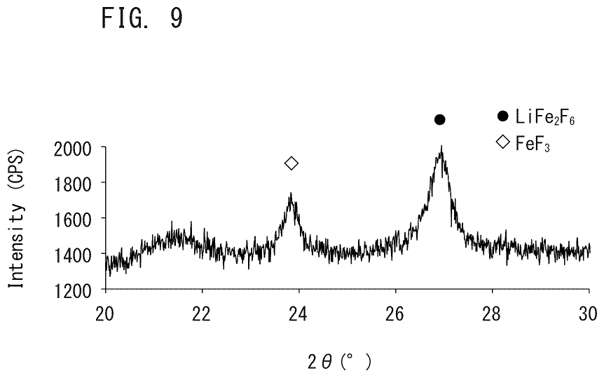

Among the results, FIG. 9 illustrates a part of the XRD pattern (enlarged view at 20°≤2θ≤30°).

As illustrated in FIG. 9, it was found that the obtained positive electrode active material had a peak derived from the crystal structure of FeF₃ and a peak derived from the crystal structure of LiFe₂F₆.

### Example 9

The positive electrode active material obtained in Example 4 was subjected to a heat treatment under similar conditions to Example 6, and the obtained positive electrode active material was subjected to X-ray diffraction measurement under similar conditions to Example 1. The results are illustrated in FIG. 8.

As illustrated in FIG. 8, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

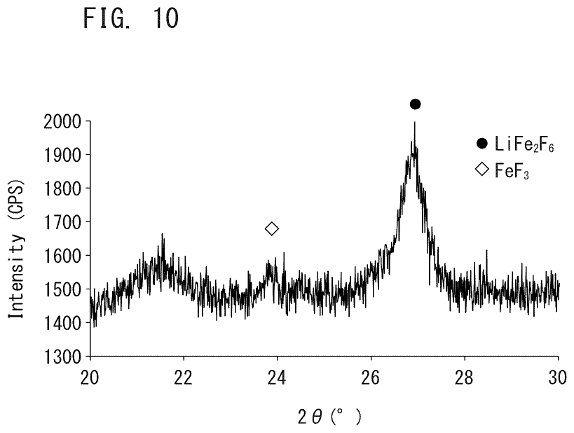

Among the results, FIG. 10 illustrates a part of the XRD pattern (enlarged view at 20°≤2θ≤30°).

As illustrated in FIG. 10, it was found that the obtained positive electrode active material had a peak derived from the crystal structure of FeF₃ and a peak derived from the crystal structure of LiFe₂F₆.

### Example 10

The positive electrode active material obtained in Example 5 was subjected to a heat treatment under similar conditions to Example 6, and the obtained positive electrode active material was subjected to X-ray diffraction measurement under similar conditions to Example 1. The results are illustrated in FIG. 8.

As illustrated in FIG. 8, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 11

(Preparation of Composite of Li_{0.4}FeF_{3.4} (Compound with x=0.4 in Formula (1)) and CNT=10% by Mass)

A positive electrode active material was obtained in a similar manner to Example 1 except that 0.458 g of ferric fluoride (FeF₃) and 0.0421 g of lithium fluoride (LiF) were subjected to the mechanical processing by using a planetary ball mill machine.

The obtained positive electrode active material was subjected to X-ray diffraction measurement under similar conditions to those in Example 1. The results are illustrated in FIG. 8.

As illustrated in FIG. 8, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 12

The positive electrode active material obtained in Example 11 was subjected to a heat treatment under similar conditions to Example 6, and the obtained positive electrode active material was subjected to X-ray diffraction measurement under similar conditions to Example 1. The results are illustrated in FIG. 8.

As illustrated in FIG. 8, a diffraction pattern of the obtained positive electrode active material coincided with both a diffraction pattern of FeF₃ of a trigonal crystal system in an R-3c space group with DB card number 00-061-0194 and a diffraction pattern of LiFe₂F₆ of a tetragonal crystal system in a P42/mnm space group with DB card number 01-074-2193, and it was found that the obtained positive electrode active material had a crystal structure similar to those of FeF₃ and LiFe₂F₆.

### Example 13

(Preparation of Composite of Li_{0.6}FeF_{3.6} (Compound with x=0.6 in Formula (1)) and CNT=20% by Mass)

A positive electrode active material was obtained in a similar manner to Example 6 except that the amount of CNTs added to the pot was 0.125 g.

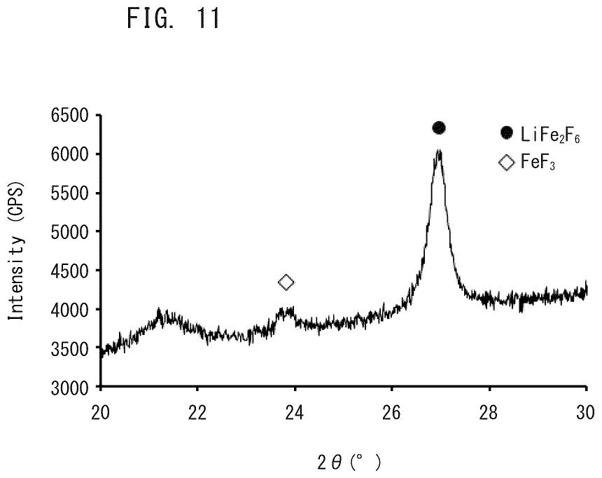

The obtained positive electrode active material was subjected to X-ray diffraction measurement under similar conditions to those in Example 1. The results are illustrated in FIG. 11.

### Example 14

(Preparation of Composite of Li_{0.7}FeF_{3.7} (Compound with x=0.7 in Formula (1)) and CNT=20% by Mass)

A positive electrode active material was obtained in a similar manner to Example 7 except that the amount of CNTs added to the pot was 0.125 g.

The obtained positive electrode active material was subjected to X-ray diffraction measurement under similar conditions to those in Example 1. Among the results, FIG. 2 illustrates a part of the XRD pattern (enlarged view at 20°≤2θ≤30°).

As illustrated in FIG. 2, it was found that the obtained positive electrode active material lost a peak derived from the crystal structure of FeF₃, and it had a peak derived from the crystal structure of LiFe₂F₆.

### Example 15

(Preparation of Composite of Li_{0.8}FeF_{3.8} (Compound with x=0.8 in Formula (1)) and CNT=20% by Mass)

A positive electrode active material was obtained in a similar manner to Example 8 except that the amount of CNTs added to the pot was 0.125 g.

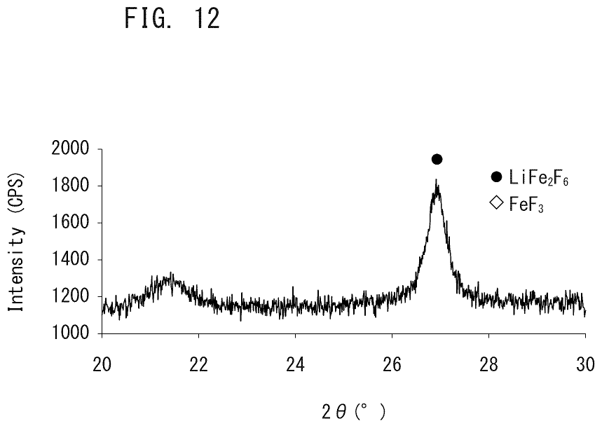

The obtained positive electrode active material was subjected to X-ray diffraction measurement under similar conditions to those in Example 1. Among the results, FIG. 12 illustrates a part of the XRD pattern (enlarged view at 20°≤2θ≤30°).

As illustrated in FIG. 12, it was found that the obtained positive electrode active material lost a peak derived from the crystal structure of FeF₃, and it had a peak derived from the crystal structure of LiFe₂F₆.

### Example 16

(Preparation of Composite of Li_{0.9}FeF_{3.9} (Compound with x=0.9 in Formula (1)) and CNT=20% by Mass)

A positive electrode active material was obtained in a similar manner to Example 1 except that 0.414 g of ferric fluoride (FeF₃) and 0.0857 g of lithium fluoride (LiF) were subjected to the first mechanical processing by using a planetary ball mill machine, and the amount of CNTs added to the pot was 0.125 g.

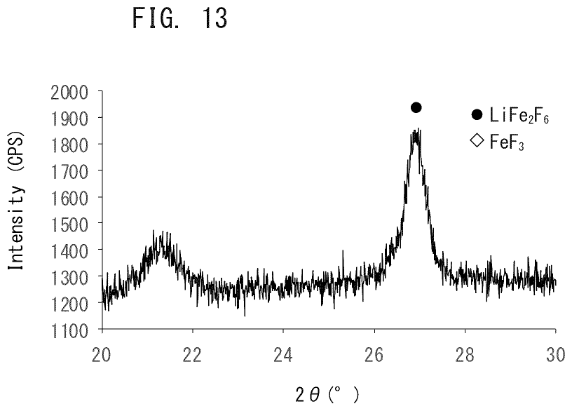

The positive electrode active material was subjected to a heat treatment under similar conditions to Example 6, and the obtained positive electrode active material was subjected to X-ray diffraction measurement under similar conditions to Example 1. Among the results, FIG. 13 illustrates a part of the XRD pattern (enlarged view at 20°≤2θ≤30°).

As illustrated in FIG. 13, it was found that the obtained positive electrode active material lost a peak derived from the crystal structure of FeF₃, and it had a peak derived from the crystal structure of LiFe₂F₆.

### Example 17

(Preparation of Composite of LiFeF₄ (Compound of Formula (1) with x=1.0) and CNT=20% by Mass)

A positive electrode active material was obtained in a similar manner to Example 9 except that the amount of CNTs added to the pot was 0.125 g.

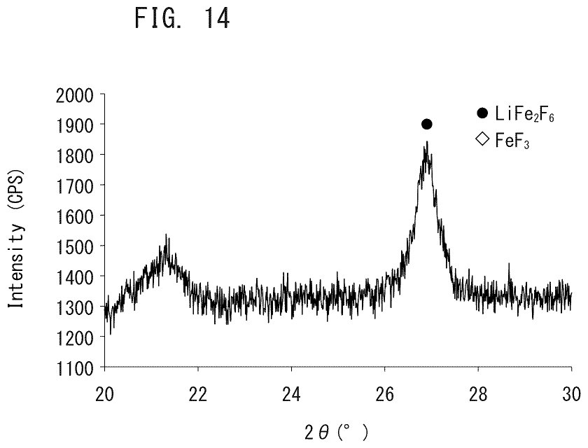

The obtained positive electrode active material was subjected to X-ray diffraction measurement under similar conditions to those in Example 1. Among the results, FIG. 14 illustrates a part of the XRD pattern (enlarged view at 20°≤2θ≤30°).

As illustrated in FIG. 14, it was found that the obtained positive electrode active material lost a peak derived from the crystal structure of FeF₃, and it had a peak derived from the crystal structure of LiFe₂F₆.

### Example 18

(Preparation of Composite of Li_{1.1}FeF_{4.1} (Compound with x=1.1 in Formula (1)) and CNT=20% by Mass)

A positive electrode active material was obtained in a similar manner to Example 1 except that 0.399 g of ferric fluoride (FeF₃) and 0.101 g of lithium fluoride (LiF) were subjected to the first mechanical processing by using a planetary ball mill machine, and the amount of CNTs added to the pot was 0.125 g.

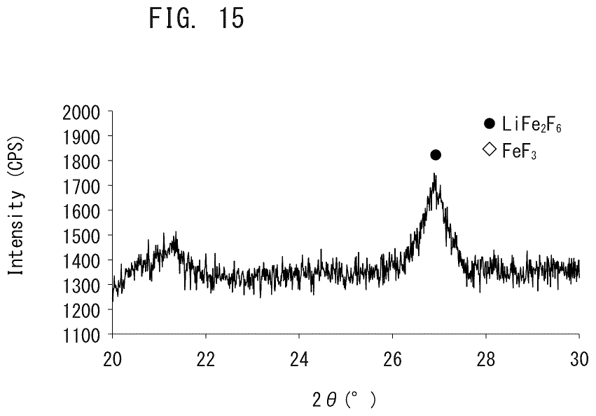

The positive electrode active material was subjected to a heat treatment under similar conditions to Example 6, and the obtained positive electrode active material was subjected to X-ray diffraction measurement under similar conditions to Example 1. Among the results, FIG. 15 illustrates a part of the XRD pattern (enlarged view at 20°≤2θ≤30°).

As illustrated in FIG. 15, it was found that the obtained positive electrode active material lost a peak derived from the crystal structure of FeF₃, and it had a peak derived from the crystal structure of LiFe₂F₆.

### Example 19

(Preparation of Composite of Li_{1.2}FeF_{4.2} (Compound with x=1.2 in Formula (1)) and CNT=20% by Mass)

A positive electrode active material was obtained in a similar manner to Example 10 except that the amount of CNTs added to the pot was 0.125 g.

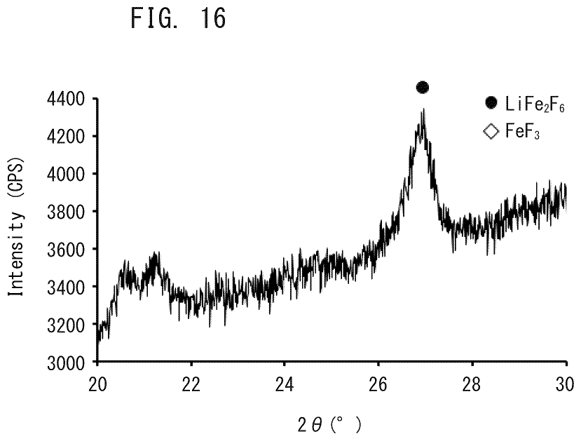

The obtained positive electrode active material was subjected to X-ray diffraction measurement under similar conditions to those in Example 1. Among the results, FIG. 16 illustrates a part of the XRD pattern (enlarged view at 20°≤2θ≤30°).

As illustrated in FIG. 16, it was found that the obtained positive electrode active material lost a peak derived from the crystal structure of FeF₃, and it had a peak derived from the crystal structure of LiFe₂F₆.

### Comparative Example 2

(Preparation of Composite of Li_{0.2}FeF_{3.2} (Compound with x=0.2 in Formula (1)) and CNT=10% by Mass)

A positive electrode active material was obtained by subjecting 0.478 g of ferric fluoride (FeF₃) and 0.022 g of lithium fluoride (LiF) to a heat treatment under the similar conditions as in Example 6 except that the first mechanical processing was performed by using a planetary ball mill machine.

### Comparative Example 3

(Preparation of Composite of Li_{1.4}FeF_{4.4} (Compound with x=1.4 in Formula (1)) and CNT=10% by Mass)

A positive electrode active material was obtained by subjecting 0.378 g of ferric fluoride (FeF₃) and 0.122 g of lithium fluoride (LiF) to a heat treatment under the similar conditions as in Example 6 except that the first mechanical processing was performed by using a planetary ball mill machine.

### Comparative Example 4

(Preparation of Composite of Li_{1.6}FeF_{4.6} (Compound with x=1.6 in Formula (1)) and CNT=10% by Mass)

A positive electrode active material was obtained by subjecting 0.366 g of ferric fluoride (FeF₃) and 0.134 g of lithium fluoride (LiF) to a heat treatment under the similar conditions as in Example 6 except that the first mechanical processing was performed by using a planetary ball mill machine.

### [Production of Lithium Ion Secondary Battery]

### (Preparation of Positive Electrode)

By dispersing 80 parts by mass of the positive electrode active material obtained in each of Examples 1 to 19 and Comparative Examples 1 to 4, 10 parts by mass of acetylene black, and 10 parts by mass of polyvinylidene fluoride in N-methylpyrrolidone as a solvent, a slurry (positive electrode mixture) including, as solid contents, 80% by mass of the positive electrode active material, 10% by mass of acetylene black, and 10% by mass of polyvinylidene fluoride was prepared. This slurry was applied onto an aluminum foil, pressed at 15 tons, and then punched with a puncher having a diameter of 10 mm to prepare a positive electrode. At this time, the mass of the positive electrode active material was adjusted to 3.5 mg.

### (Preparation of Coin-Type Cell)

The prepared positive electrode (diameter: 10 mm) was placed on a positive electrode can, a porous polyethylene film serving as a separator was placed thereon, and the resulting product was pressed with a polypropylene gasket. Thereafter, a Li negative electrode having a thickness of 0.5 mm was placed thereon, and a spacer for thickness adjustment was placed thereon. Thereafter, as a non-aqueous electrolytic solution, a mixed solvent of ethylene carbonate and diethyl carbonate (volume ratio: 5:5) in which 1 mol/L lithium hexafluorophosphate was dissolved was added between the positive electrode can and the negative electrode, the separator was impregnated with the mixed solvent, and a negative electrode can was placed thereon and sealed to prepare a coin-type cell (lithium ion secondary battery).

### [Evaluation of Battery Performance]

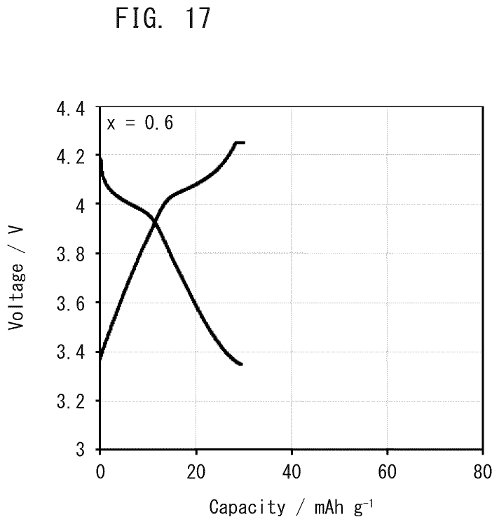

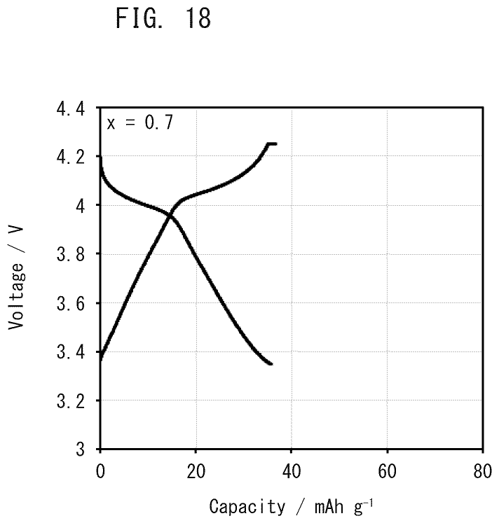

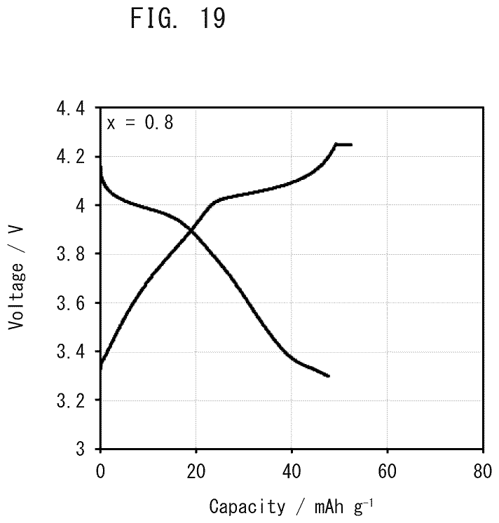

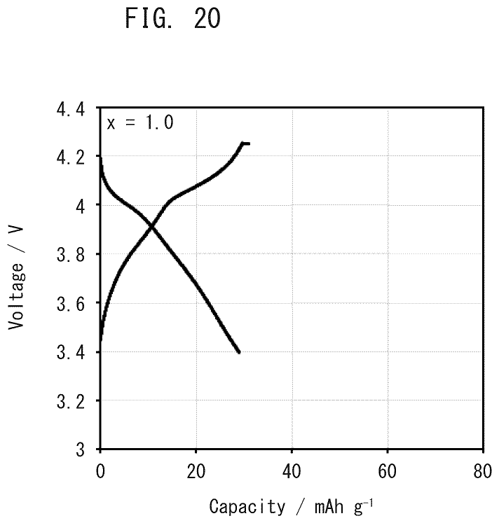

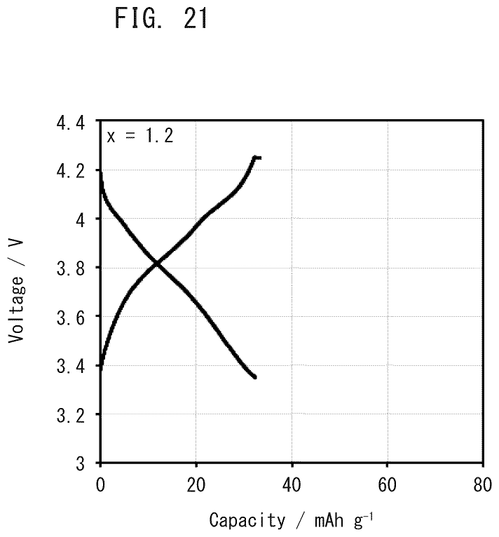

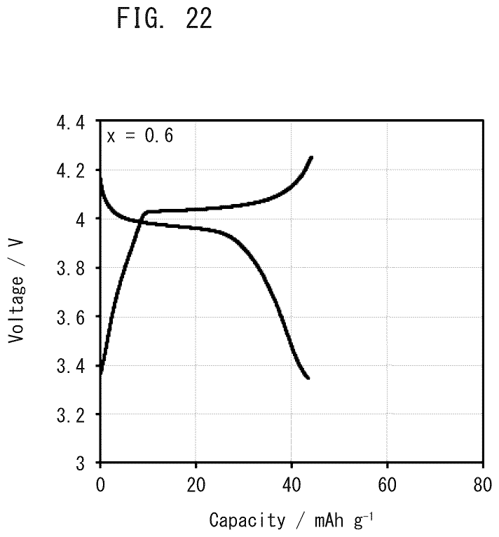

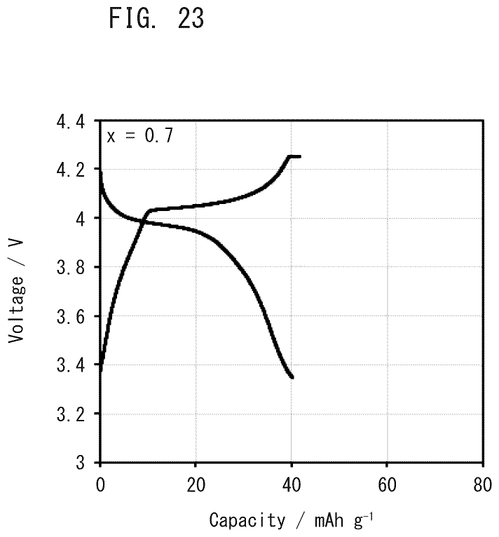

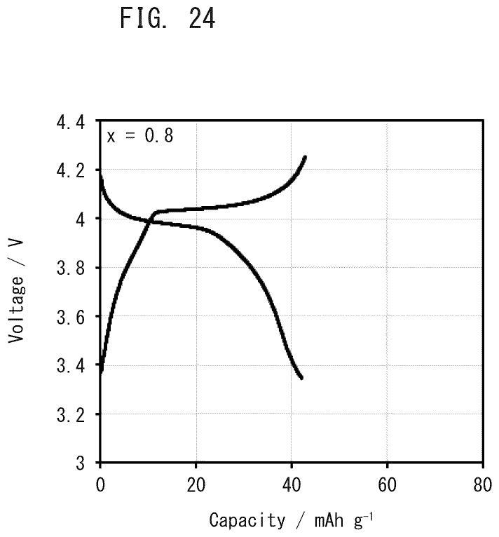

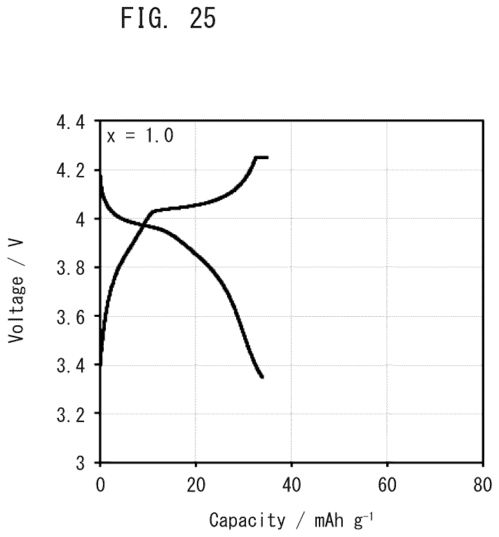

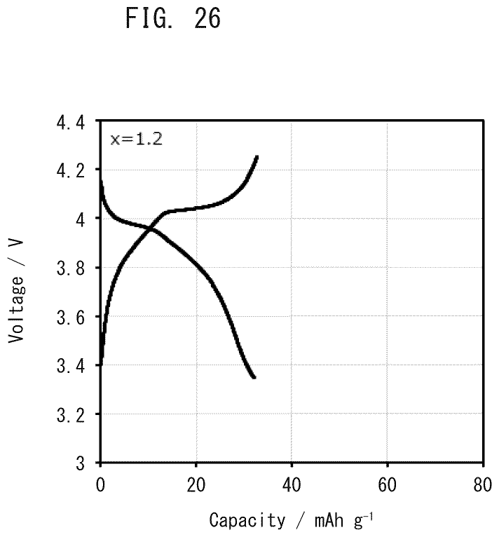

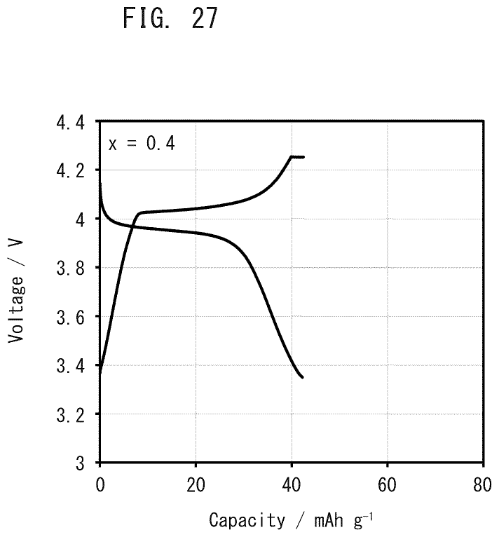

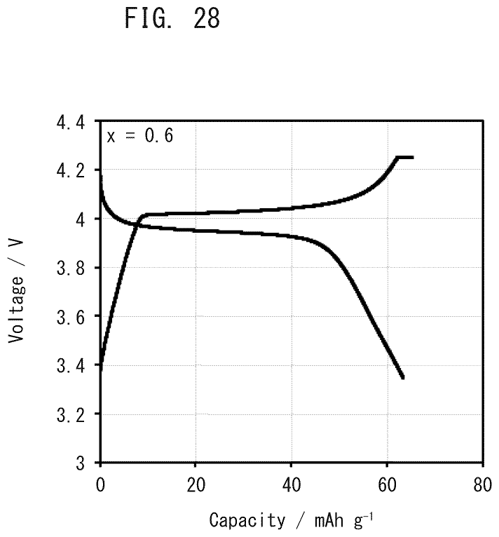

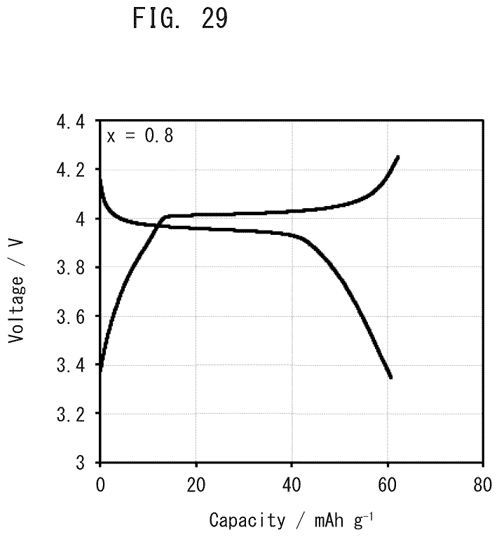

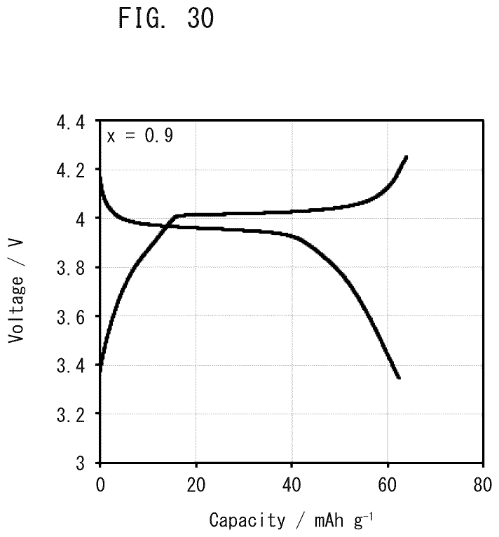

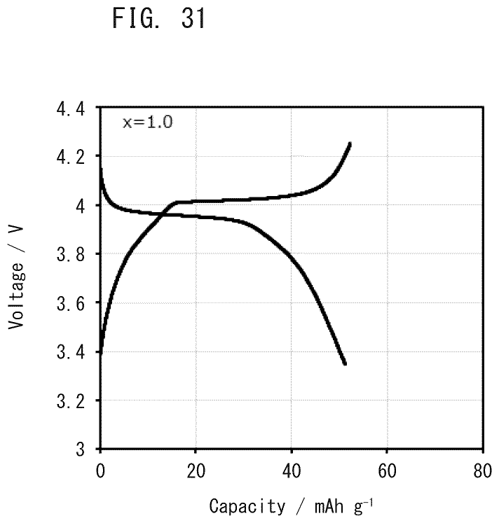

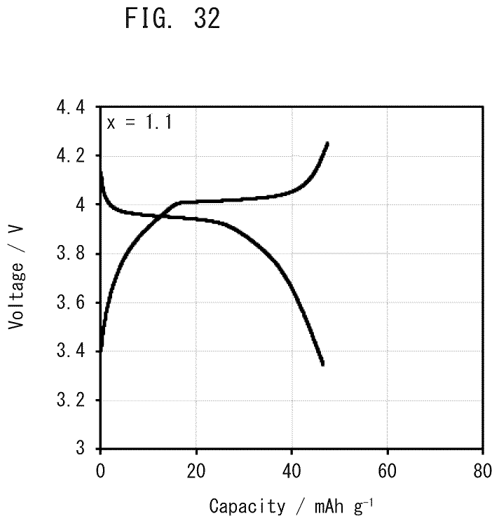

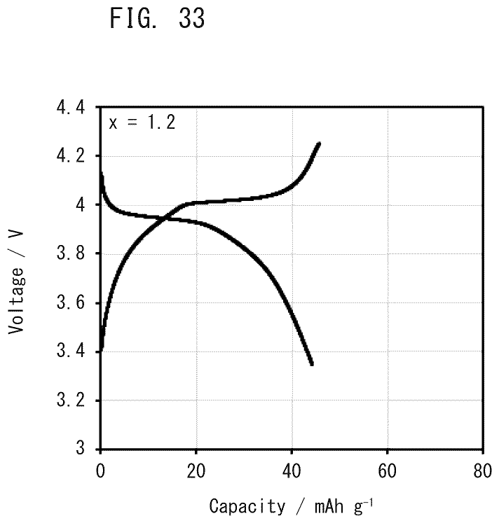

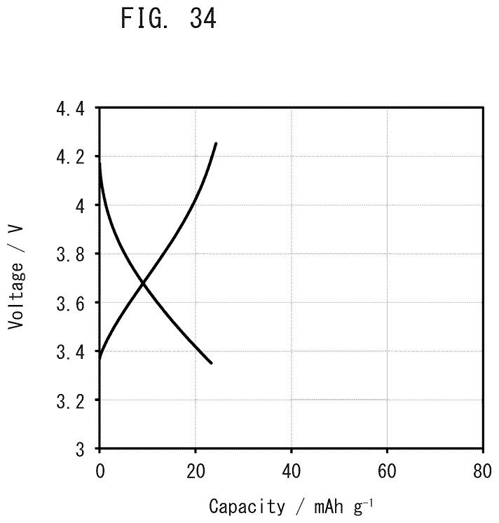

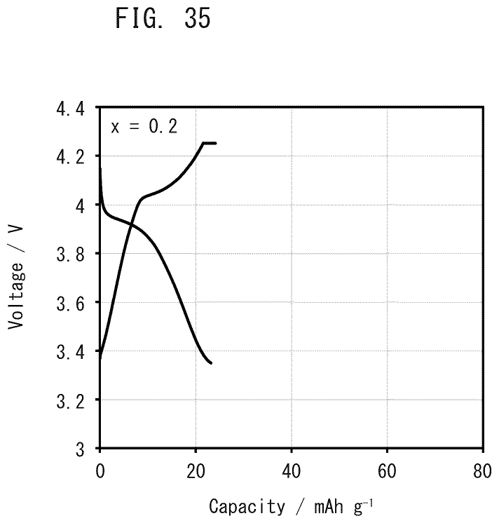

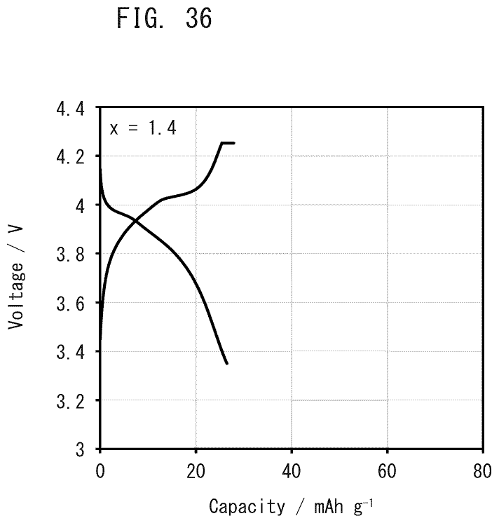

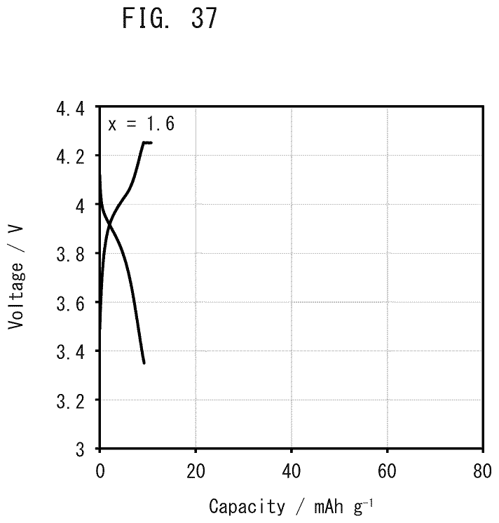

Battery performance of the prepared coin-type cell was evaluated. Specifically, the prepared coin-type cell was charged and discharged at a constant current having a current value of 5 mA/g per mass of the positive electrode active material. During charge and discharge at a constant current, an upper limit voltage was 4.25 V, and a lower limit voltage was 3.35 V. A resting time after charge and discharge was 10 minutes. A charge-discharge capacity (mAh/g) was calculated per unit mass of the positive electrode active material. Charge-discharge curves of charge and discharge at a constant current in Examples 1 to 10, Examples 12 to 19, and Comparative Examples 1 to 4 are illustrated in FIG. 4 and FIGS. 17 to 37.

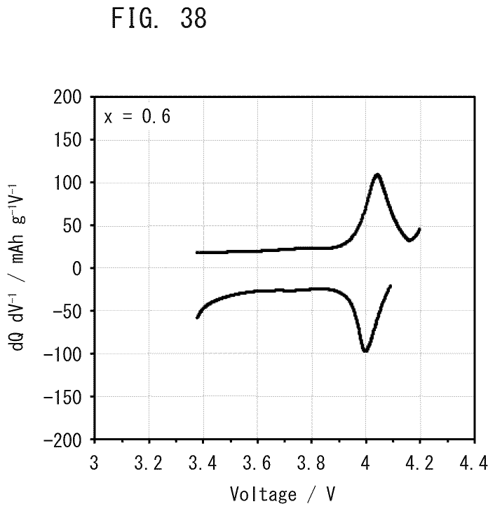

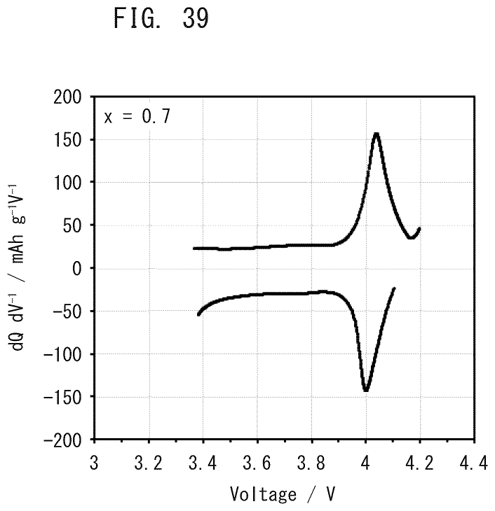

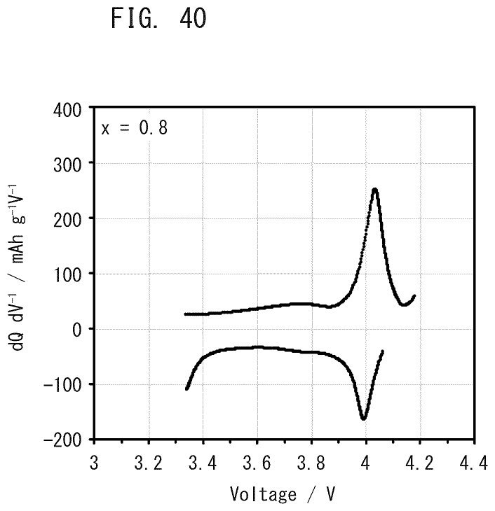

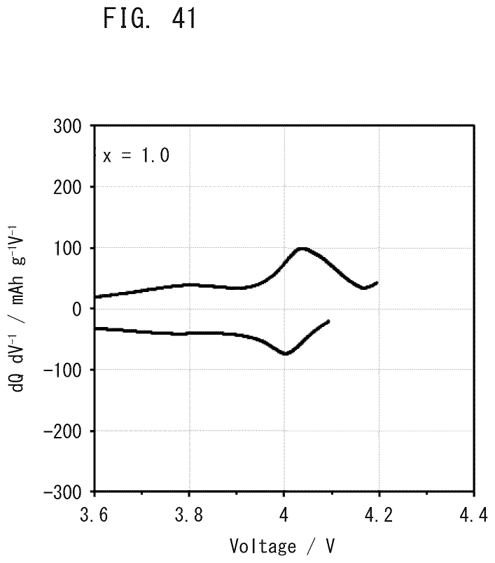

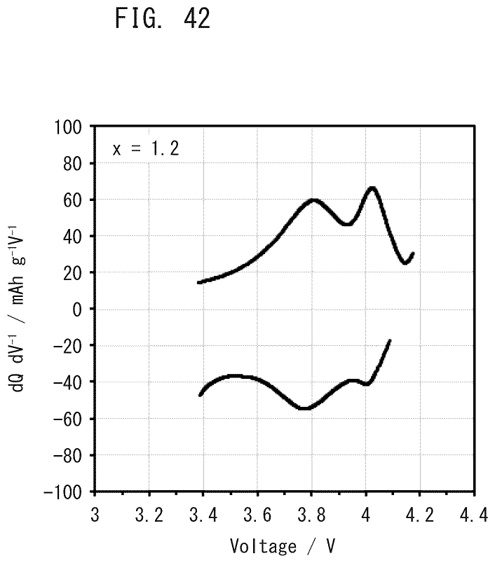

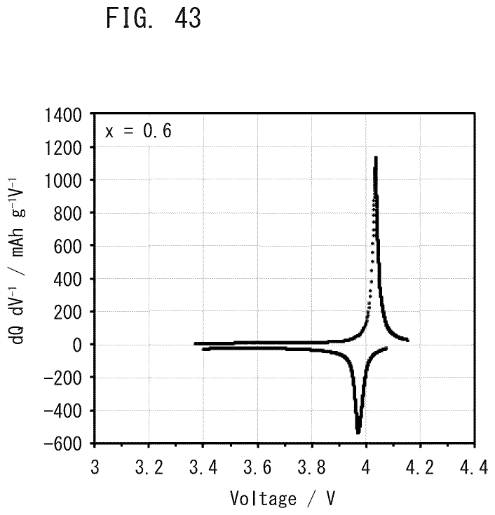

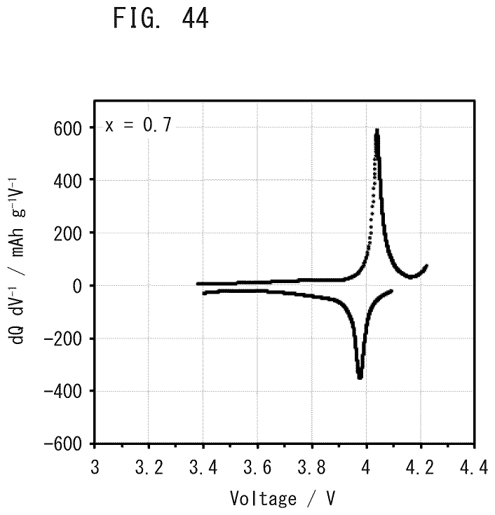

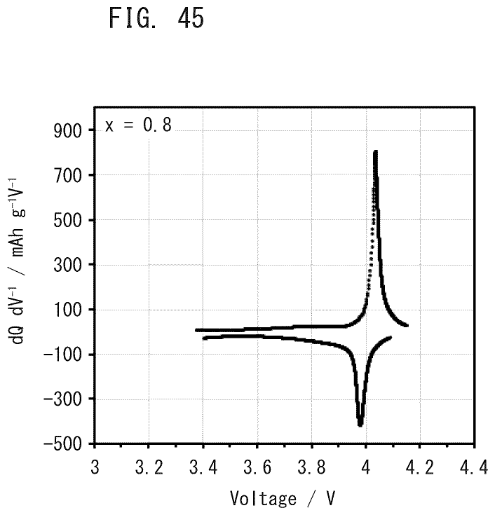

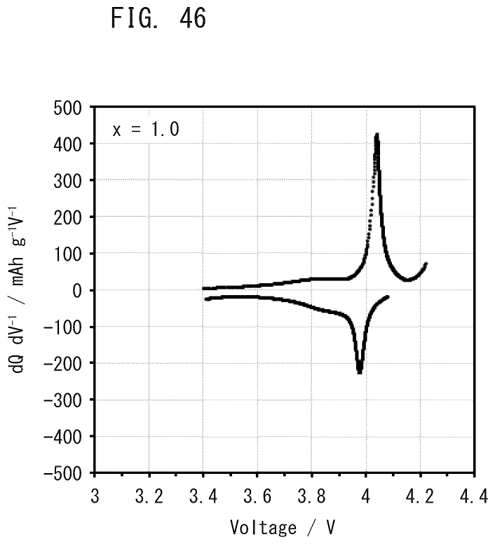

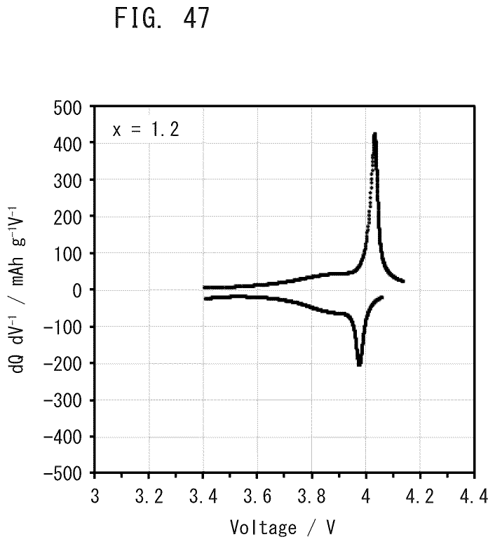

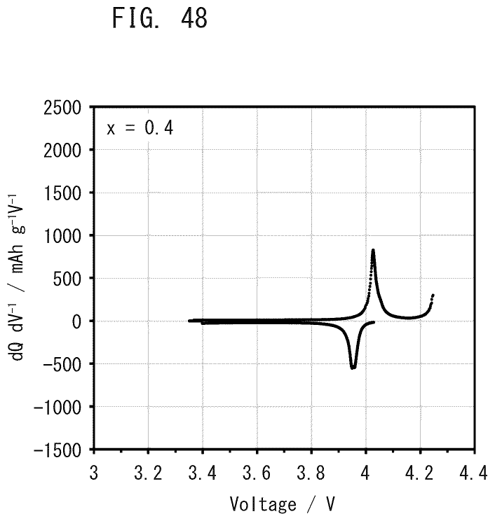

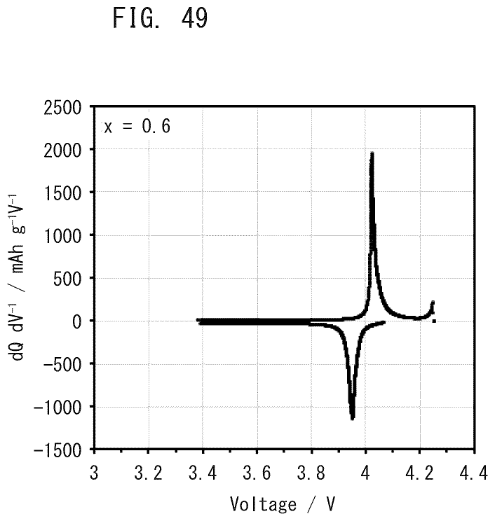

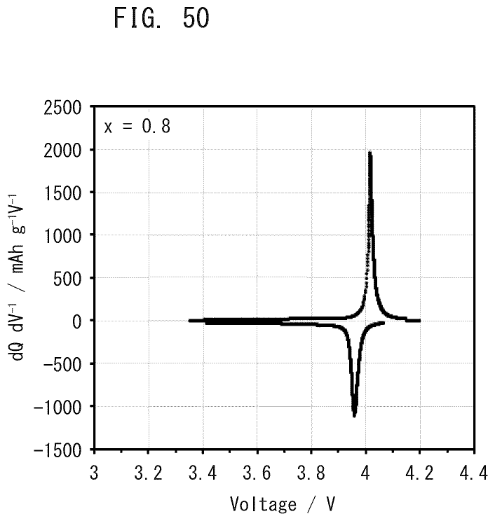

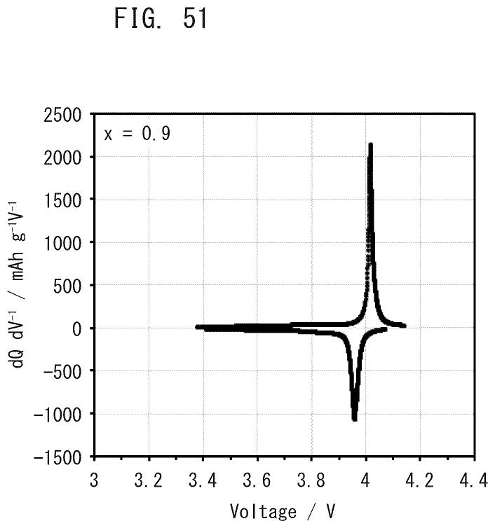

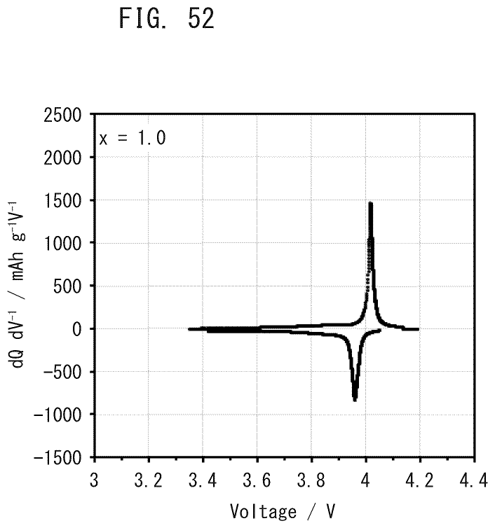

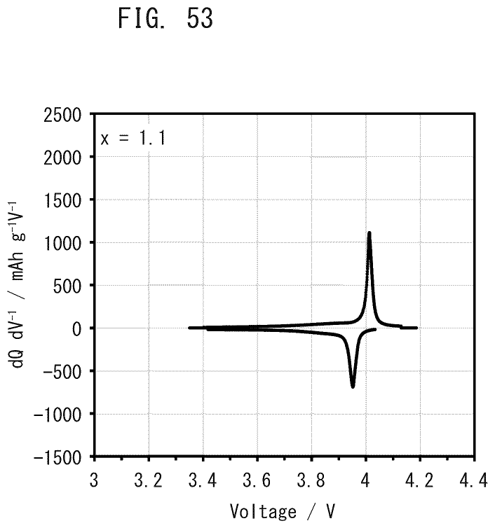

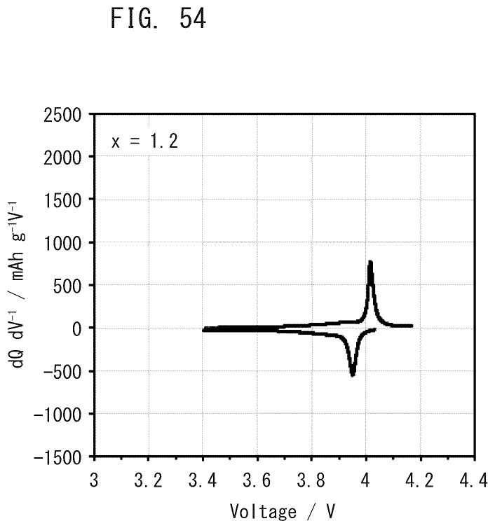

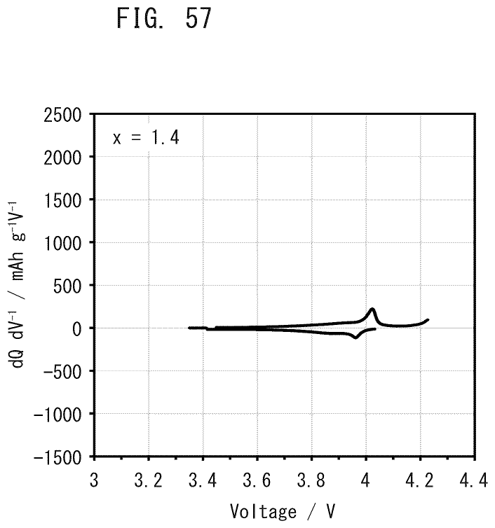

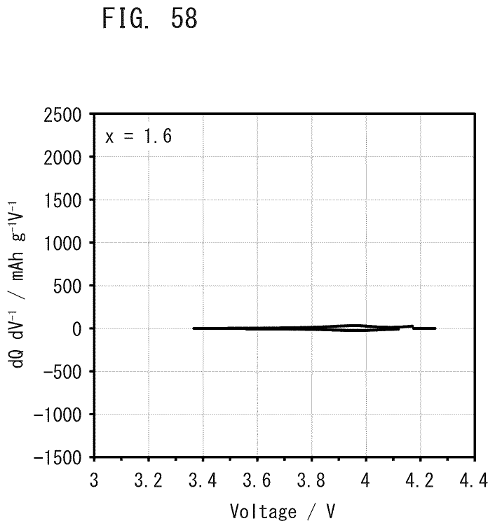

From each of the obtained charge-discharge curves, a dQ/dV plot was created with the horizontal axis representing a voltage and the vertical axis representing a value obtained by differentiating a capacity with the voltage (dQ/dV, dQdV⁻¹), and a voltage at which a chemical reaction occurred (reaction voltage) was determined from a peak voltage of the dQ/dV plot during discharge. The dQ/dV plots of Examples 1 to 10, Examples 12 to 19 and Comparative Examples 1 to 4 are illustrated in FIGS. 5 and 38 to 58.

As illustrated in FIGS. 5 and 38 to 54, in each of Examples 1 to 10 and 12 to 19 to which the present invention was applied, a peak voltage of the dQ/dV plot during discharge was as high as 3.94 V to 4.01 V, and it was confirmed that the chemical reaction occurred at a high voltage inherent to the compound represented by formula (1).

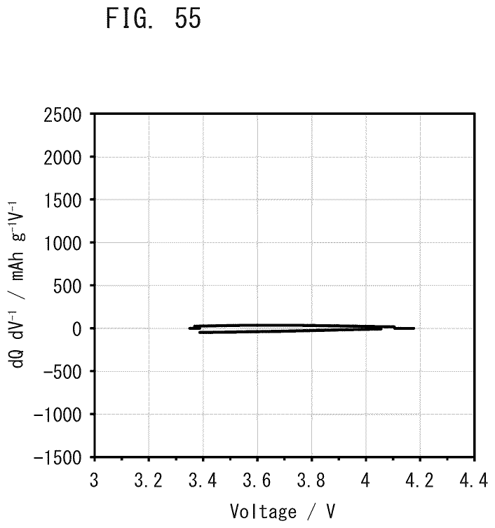

On the other hand, in Comparative Example 1 (LiFeF₃) in which the positive electrode active material did not contain the compound represented by formula (1), as illustrated in FIG. 55, a peak voltage of the dQ/dV plot during discharge was not observed around 4 V, and only a broad peak was observed in the operating voltage range. It is considered that in order to observe a clear reaction of Fe²⁺/Fe³⁺, it is necessary to lower a lower limit of the operating voltage range, and in Comparative Example 1, a chemical reaction occurs at a voltage lower than the lower limit voltage of 3.35 V of the present Examples.

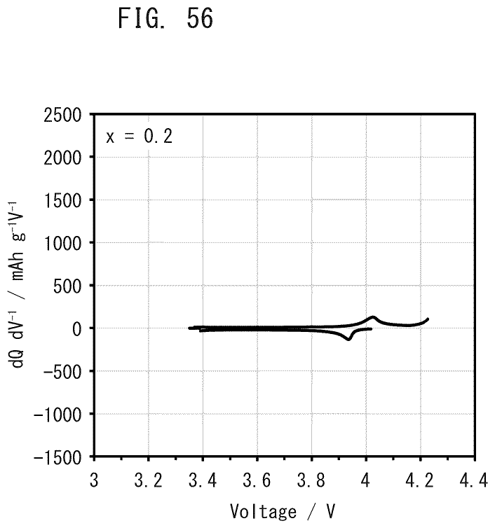

In addition, in Comparative Examples 2 to 4 in which x in formula (1) is out of the range of the present invention, as illustrated in FIGS. 56 to 58, the peak depth in the peak voltage of the dQ/dV plot during discharge observed around 4 V was shallower than those in Examples 6 to 10 and Example 12.

### Example 20

(Preparation of Composite of LiFeF₄ (Compound of Formula (1) with x=1.0) and CB=20% by Mass)

A positive electrode active material was obtained in a similar manner to Example 17 except that carbon black (CB) was used instead of CNT.

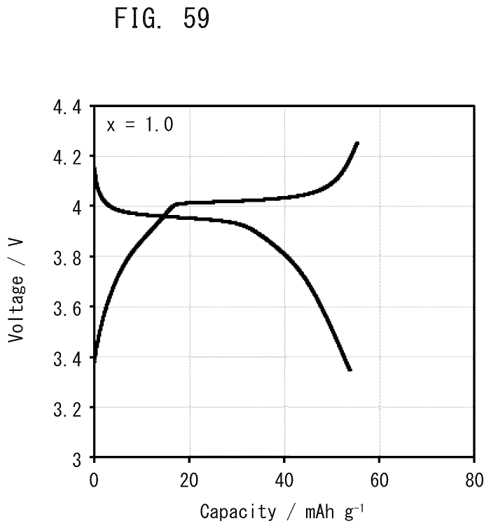

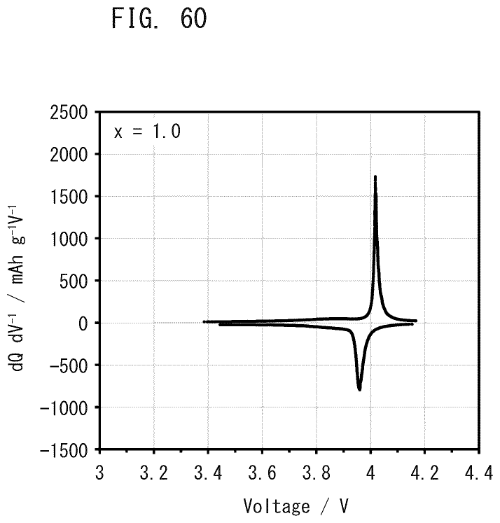

Using the obtained positive electrode active material, a coin type cell (lithium ion secondary battery) was prepared in a similar manner to Examples 1 to 19, and battery performance was evaluated. A charge-discharge curve of charge and discharge at a constant current is illustrated in FIG. 59. In addition, from the obtained charge-discharge curve, a dQ/dV plot was created in the same manner as in Examples 1 to 19. The results are illustrated in FIG. 60.

As illustrated in FIG. 59, it has been confirmed that the lithium ion secondary battery using the positive electrode active material of Example 20 using CB as carbon has a discharge capacity of 53.6 mAhg⁻¹, which is equivalent to the discharge capacity of 51 mAhg⁻¹ of the lithium ion secondary battery using the positive electrode active material of Example 17 using CNT as carbon. In addition, as illustrated in FIG. 60, the peak voltage of the dQ/dV plot during discharge was as high as 3.960 V, and it was confirmed that a chemical reaction occurred at a high voltage inherent to the compound represented by formula (1).

Tables summarizing values of the peak voltage during charge and discharge, the peak height (or the peak depth) at the peak voltage, and the discharge capacity in the above results are illustrated in Tables 1 to 4.

TABLE 1

| | CNT 10% by mass no heat treatment | | | | | |
|---|---|---|---|---|---|---|
| | | During charge | | During discharge | | |
| | | Peak | Peak | Peak | | Discharge |
| | | voltage | height | voltage | Peak depth | capacity |
| | x | (V) | (mAh/gV) | (V) | (mAh/gV) | (mAh/g) |
| Example 1 | 0.6 | 4.048 | 105 | 3.997 | 96.7 | 29.2 |
| Example 2 | 0.7 | 4.042 | 154 | 4.001 | 141.5 | 35.6 |
| Example 3 | 0.8 | 4.037 | 251 | 3.991 | 161.9 | 47.6 |
| Example 4 | 1.0 | 4.046 | 98.3 | 4.006 | 71.5 | 28.9 |
| Example 5 | 1.2 | 4.039 | 64.6 | 4.004 | 40.8 | 32.1 |
| Example 11 | 0.4 | 4.026 | 181 | 3.982 | 140 | 31.3 |

TABLE 2

| | CNT 10% by mass heat treatment | | | | | |
|---|---|---|---|---|---|---|
| | | During charge | | During discharge | | |
| | | Peak | Peak | Peak | | Discharge |
| | | voltage | height | voltage | Peak depth | capacity |
| | x | (V) | (mAh/gV) | (V) | (mAh/gV) | (mAh/g) |
| Example 6 | 0.6 | 4.034 | 1103 | 3.970 | 527.2 | 43.4 |
| Example 7 | 0.7 | 4.039 | 571 | 3.977 | 346.2 | 40.0 |
| Example 8 | 0.8 | 4.035 | 793 | 3.978 | 410.0 | 41.9 |
| Example 9 | 1.0 | 4.041 | 411 | 3.975 | 224,7 | 33.9 |
| Example 10 | 1.2 | 4.034 | 413 | 3.975 | 204.2 | 31.9 |
| Example 12 | 0.4 | 4.029 | 797 | 3.958 | 544.4 | 42.0 |

TABLE 3

| | CNT 20% by mass heat treatment | | | | | |
|---|---|---|---|---|---|---|
| | | During charge | | During discharge | | |
| | | Peak | Peak | Peak | | Discharge |
| | | voltage | height | voltage | Peak depth | capacity |
| | x | (V) | (mAh/gV) | (V) | (mAh/gV) | (mAh/g) |
| Example 13 | 0.6 | 4.022 | 1927 | 3.951 | 1117 | 63.2 |
| Example 14 | 0.7 | 4.012 | 1677 | 3.940 | 1256 | 56.2 |
| Example 15 | 0.8 | 4.015 | 1932 | 3.957 | 1100 | 60.6 |
| Example 16 | 0.9 | 4.018 | 2079 | 3.959 | 1062 | 62.2 |
| Example 17 | 1.0 | 4.017 | 1430 | 3.959 | 820 | 51.0 |
| Example 18 | 1.1 | 4.014 | 1053 | 3.953 | 682 | 46.4 |
| Example 19 | 1.2 | 4.016 | 754 | 3.950 | 533 | 44.0 |
| Example 20 | 1.0 | 4.017 | 1721 | 3.960 | 796 | 53.6 |

TABLE 4

| | CNT 10% by mass heat treatment | | | | | |
|---|---|---|---|---|---|---|
| | | During charge | | During discharge | | |
| | | Peak | Peak | Peak | | Discharge |
| | | voltage | height | voltage | Peak depth | capacity |
| | x | (V) | (mAh/gV) | (V) | (mAh/gV) | (mAh/g) |
| Comparative | — | 3.690 | 35.6 | 3.387 | 48.7 | 23.3 |
| Example 1 | | | | | | |
| Comparative | 0.2 | 4.027 | 126 | 3.938 | 131 | 23.1 |
| Example 2 | | | | | | |
| Comparative | 1.4 | 4.024 | 218 | 3.964 | 113 | 26.4 |
| Example 3 | | | | | | |
| Comparative | 1.6 | 3.964 | 32.5 | 3.962 | 26.2 | 9.2 |
| Example 4 | | | | | | |

From the above-described results, it has been found that the present invention can provide an Fe-based positive electrode active material capable of operating at a high voltage, and a lithium ion secondary battery including the positive electrode active material.

In addition, it has been found that by subjecting the positive electrode active material of the present invention to heat treatment, the capacity of the lithium ion secondary battery including the positive electrode active material can be increased.

What is claimed is:

1. A positive electrode active material comprising a lithium-iron composite fluoride as a principal component and including carbon, wherein
the lithium-iron composite fluoride is represented by the following formula (1): 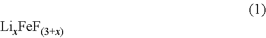
in the formula (1), x is a number satisfying 0.4≤x≤1.2.

2. The positive electrode active material according to claim 1, wherein a mass ratio (M₁:M₂) between a mass (M₁) of the lithium-iron composite fluoride and a mass (M₂) of the carbon is 90:10 to 60:40.

3. The positive electrode active material according to claim 1, wherein a mass ratio (M₁:M₂) between a mass (M₁) of the lithium-iron composite fluoride and a mass (M₂) of the carbon is 90:10 to 80:20.

4. The positive electrode active material according to claim 1, wherein the carbon is a carbon nanotube or carbon black.

5. A lithium ion secondary battery comprising a positive electrode, a negative electrode, and an electrolyte, wherein the positive electrode contains the positive electrode active material according to claim 1.

6. The lithium ion secondary battery according to claim 5, wherein a dQ/dV plot during discharge in a charge-discharge cycle has a peak in a range of 3.94 to 4.01 V.

7. A lithium ion secondary battery comprising a positive electrode, a negative electrode, and an electrolyte, wherein
the positive electrode contains a positive electrode active material, and
the positive electrode active material includes a lithium-iron composite fluoride as a principal component and carbon, and
the lithium-iron composite fluoride is represented by the following formula (1): 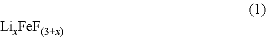
in the formula (1), x is a number satisfying 0.4≤x≤1.2,
a dQ/dV plot during discharge in a charge-discharge cycle has a peak in the range of 3.94 to 4.01 V.
